(19) United States
(12) Patent Application Publication
(10) Pub. No.: US 2026/0289982 A1
(43) Pub. Date: Sep. 24, 2026

(54) OBJECT DETECTION USING MULTIPLE OBJECT DETECTORS

(71) Applicant: Five AI Limited, Cambridge (GB)

(72) Inventors: Kemal Oksuz, Cambridge (GB); Thomas Joy, Cambridge (GB); Puneet Kumar Dokania, Cambridge (GB)

(73) Assignee: Five AI Limited, Cambridge (GB)

(21) Appl. No.: 19/484,729

(22) PCT Filed: May 15, 2024
(86) PCT No.: PCT/EP2024/063437

§ 371 Date: Nov. 14, 2025

(30) Foreign Application Priority Data
May 16, 2023 (GB) 2307289.5
Jun. 2, 2023 (GB) 2308288.6

(51) Int. Cl. G06V 10/776; G06V 10/25; G06V 10/26; G06V 10/764

(52) U.S. Cl. CPC G06V 10/776; G06V 10/25; G06V 10/267; G06V 10/764

(57) ABSTRACT

A method of detecting one or more objects in a scene using multiple calibrated object detectors, is disclosed. Each calibrated object detector is applied to the scene, resulting in one or more predicted object regions for each calibrated object detector and an uncalibrated confidence score for each predicted object region. For each calibrated detector, its score calibration function is used to determine a calibrated confidence score for each predicted object region. A reduction algorithm is applied to a combined prediction set comprising the one or more predicted object regions for each object detector and their calibrated confidence scores, resulting in a reduced prediction set.

### TECHNICAL FIELD

The present disclosure pertains to methods for calibrating an object detector, and a method of using multiple calibrated object detectors to detect object(s) present in a scene, and computer systems and computer programs for implementing the same.

### BACKGROUND

Several real-world applications such as autonomous driving [4, 58, 18], medical imaging [65], surveillance [63] or auto-labelling [33, 28] require accurate object detectors. As a result, various aspects of object detectors, including data augmentation [15, 10, 16, 72], exploiting unlabelled additional data [73, 70], model design [25, 45, 39, 68, 22] and loss functions [9, 51, 62, 44, 42, 38, 37], have been extensively studied. Surprisingly, ensembling detectors either in the form of a Deep Ensemble (DE) by using the same model with different initializations or as a MoE by combining different type of models has received little attention [36, 7] despite their success in the classification literature [34].

### SUMMARY

A method of detecting one or more objects in a scene using multiple calibrated object detectors, is presented. Each calibrated object detector is applied to the scene, resulting in one or more predicted object regions for each calibrated object detector and an uncalibrated confidence score for each predicted object region. For each calibrated detector, its score calibration function is used to determine a calibrated confidence score for each predicted object region. A reduction algorithm is applied to a combined prediction set comprising the one or more predicted object regions for each object detector and their calibrated confidence scores, resulting in a reduced prediction set.

A first aspect of the present disclosure provides a computer-implemented method of calibrating an object detector, the method comprising:
for each scene of an annotated sensor data set:
applying the object detector to the scene, resulting in one or more predicted object regions and an uncalibrated confidence score associated with each predicted object region,
calculating a corresponding target confidence score for each predicted object region as an intersection over union (IOU) between the predicted object region and a corresponding ground truth (annotated) object region associated with the annotated scene,
thereby obtaining a set of observations, each observation comprising an uncalibrated confidence score and a corresponding target confidence score; and
fitting a score calibration function to the set of observations, thereby enabling the score calibration function to predict a calibrated confidence score for a given uncalibrated confidence score.

In embodiments, applying the object detector to the scene may additionally result in a predicted class for each predicted object region.

The observations are input-output pairs, where the input comprises the uncalibrated confidence score and the output comprises the corresponding target confidence score (the target score for calibration).

A calibrated object detector means an object detector for which a score calibration function has been determined in this manner. Given an object region predicted by the object detector in an unannotated scene and an uncalibrated confidence score, the score calibration function can be used (once fitted to the uncalibrated-target score pairs) to obtain a calibrated confidence score for that predicted object region. Ground truth is not available for an unannotated scene. The calibrated confidence score is a prediction of the IoU for the predicted object region with respect to ground truth, but obtained without the use of ground truth.

Once calibrated in this manner, multiple object detectors can be combined using their calibrated confidence scores.

A second aspect herein provides a computer-implemented method of detecting one or more objects in a scene using multiple calibrated object detectors, the method comprising:
applying each calibrated object detector to the scene, resulting in one or more predicted object regions for each calibrated object detector and an uncalibrated confidence score for each predicted object region;
for each calibrated detector, using its score calibration function to determine a calibrated confidence score for each predicted object region; and
applying a reduction algorithm to a combined prediction set comprising the one or more predicted object regions for each object detector and their calibrated confidence scores, resulting in a reduced prediction set.

In embodiments, applying each calibrated object detector may result in a predicted class for each predicted object region.

In some such cases, the reduction algorithm may be applied for each predicted class independently (if the object detectors do not operate on identical sets of classes, the predicted classes may be transformed as needed to a common set of classes before this step).

The combined prediction set combines object detections from the multiple calibrated object detectors (an object detection being a predicted object region and its calibrated confidence score).

The reduction algorithm is used to account for duplicate object detection(s) in the combined prediction set, in a way that respects their calibrated confidence scores. The identification of duplicate detections typically considers the extent of overlap between predicted object regions as well as their calibrated scores. For example, the reduction algorithm may involve selectively re-scoring the predicted object regions, such that the calibrated confidence scores are reduced for certain object region(s), taking into account how likely they are to be duplicates. For example, the predicted object region having a highest calibrated confidence score across all of the object detectors may be identified (e.g., overall highest, or highest within a given class), and any other object region (or any other object region belonging to the same class) that is determined to overlap with the highest-scoring region may have its calibrated score reduced in response. For example, the calibrated confidence score of the overlapping region may be reduced in dependence on an extent of overlap (e.g., IoU) with the highest-scoring region. The highest score (overall, or in each class) may be retained unaltered.

Note that the term ‘reduction’ encompasses both ‘hard’ and ‘soft’ reduction. The latter is used herein to refer to a process of re-scoring the detections to account for the likelihood of duplicate detections, without reducing the number of detections (in this approach, possible duplicate detections have their scores reduced but are not necessarily removed). ‘Hard’ reduction refers to a process in which the number of detections is reduced. Note that soft reduction may be followed by hard reduction, e.g. in a final post-processing step, e.g. to remove any detections whose calibrated scores are below a defined threshold following the re-scoring. A detection may have a calibrated confidence score that is above this threshold initially, but reduced below the threshold by the re-scoring, meaning, it is removed in this final post-processing step.

As an alternative or in addition to re-scoring, the reduction algorithm may also refine the object regions. For example, the reduction algorithm may comprise determining a weighted average of the predicted object regions (e.g. within a given predicted class) based on the re-calibrated scores.

For example, for each of the remaining object regions after NMS, the final object region can be obtained as the weighted average of all overlapping object regions (or all object regions within a given class) considering their calibrated confidence scores or overlap, or both.

In the described embodiments, the score(s) for any overlapping region(s) are reduced via soft non-maximal suppression (NMS). Note, the term NMS is used broadly herein, and encompasses not only ‘classical’ NMS but also variants such as soft NMS.

In the described embodiments, the reduction algorithm combines soft NMS with a process of refining the remaining predicted object regions from the combined prediction set based on the calibrated confidence score and the overlap of each remaining predicted object region with other predicted object regions.

The score calibration function can, for example, be a parameterized function, where the fitting involves fitting one or more parameters of the score calibration function to the observations. For example, an isotonic regression approach may be used to fit an isotonic score calibration function to the observations. The score calibration function can take other forms, such as a trainable machine learning (ML) model (such as a neural network) that is fitted to the observations, using ML training techniques (such as gradient descent/ascent with backpropagation of errors based on a regression loss function that measures difference between the inputs and outputs, such as a mean-square-error loss).

The predicted/annotated object region could for example be a bounding box, rotated bounding box, segmentation regions etc. Note, the term object detector is used broadly to encompass any form of object localization, including bounding box detection, bounding box rotation, scene segmentation.

A scene may be 2D or 3D, and may, for example, take the form of an image, point cloud, surface mesh representation, voxel representation etc. The scene may be captured using one or multiple sensor modalities, such as camera, lidar and/or radar modalities.

The object detectors may, for example, be machine learning (ML) models with different architectures, in a mixture of experts (MoE) approach.

### BRIEF DESCRIPTION OF FIGURES

Particular embodiments will now be described, by way of example only, with reference to the following schematic figures, in which:

FIG. 1(a-c) show confidence score distributions of RS R-CNN, ATSS and PAA.

FIG. 1(d-i) show outputs of the detectors on an example image.

FIG. 2 (a-b) shows pie charts representing the % of detections obtained from a certain detector in the final detection set of MoEs.

FIG. 3(a) shows a schematic block diagram of a late calibration architecture for object detection

FIG. 3(b) shows a schematic block diagram of an early calibration architecture for object detection.

FIG. 4 (a-b) shows the effect of background removal threshold on AP and NMS processing time.

FIG. 5 presents how LAECE, LAACE and LAMCE change when the cardinality of the hold-out validation set changes.

FIG. 6 shows the contribution of MOCAE on performance aspects.

FIG. 7 shows a highly schematic block diagram of an AV runtime stack.

### DETAILED DESCRIPTION

Despite its potential on improving the accuracy, obtaining a Mixture of Experts (MoE) by combining different types of detectors is not explored for object detection. The main challenge to obtain an accurate MoE is the miscalibration of the single detectors. This miscalibration originates mainly from the diversities in the detector architectures, classifiers and loss functions. The described embodiments provide an object detection mechanism referred to herein as “Mixture of Calibrated Experts (MOCAE)”. MOCAE is a simple but highly effective principled approach that enables accurate MOEs for object detection by combining different object detectors. Naively combining these experts in a similar way to the well-known Deep Ensembles (DeEs) does not result in an effective MoE. The incompatibility between the confidence score distribution of different detectors is identified as the primary reason for such failure cases.

MOCAE first calibrates each individual detector against a target calibration function. The predictions from different detectors in the mixture are filtered and refined. Extensive experiments on object detection, instance segmentation and rotated object detection demonstrate the effectiveness of MOCAE. MOCAE improves (i) three strong object detectors on COCO test-dev by 2.4 AP by reaching 59.0 AP; (ii) instance segmentation methods on the challenging long-tailed LVIS dataset by 2.3 AP; and (iii) all existing rotated object detectors by reaching 82.62 AP₅₀ establishing a new state-of-the-art (SOTA).

Mechanically, a DE requires combining predictions from multiple models; mathematically this approximates the posterior predictive through Monte-Carlo sampling of the parameter space. MoE however performs this sampling on the distribution of model functions, thereby reducing the bias and as such one would expect an MoE to have superior performance over its DE counterpart. Obtaining a MoE is non-trivial as the confidence score distributions of different types of detectors are typically not calibrated. The confidence scores for each detection are generally incompatible across detectors, due to different training procedures, post-processing operations or architectures. Among different factors causing this miscalibration, one specific case is related to the architecture of the used detector.

In order for an MoE to faithfully combine the detections so that the detectors complement each other, the underlying predictive distributions for each posterior estimate must be compatible. To achieve this, it is observed that calibrating their confidence scores using the same underlying target function is beneficial. This brings them to a common ground where the confidence scores of different detectors are now compatible.

For example, some recent detectors employ an additional auxiliary head to predict localisation confidence Then the final confidence is taken as an increasing function of classification and localisation confidences. Consequently, the auxiliary head choice such as centerness or Intersection over Union (IoU) as well as the aggregation function such as multiplication or geometric mean affect the confidence scores. Arguably, another factor causing the confidence misalignment across the detectors is the used classifier, which commonly vary between a softmax or sigmoid classifiers for each class. Besides, following from the classifiers, different backbones, loss functions and the training length affect the confidence of the model.

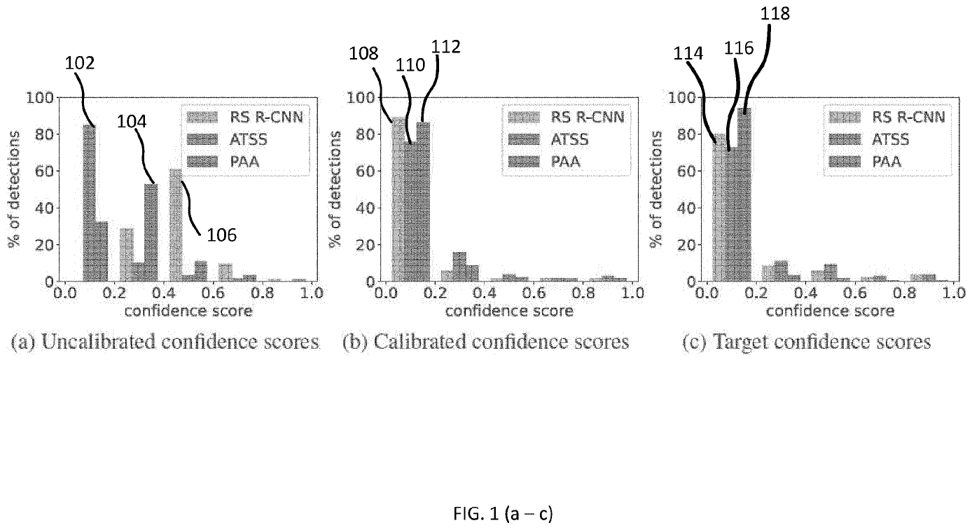

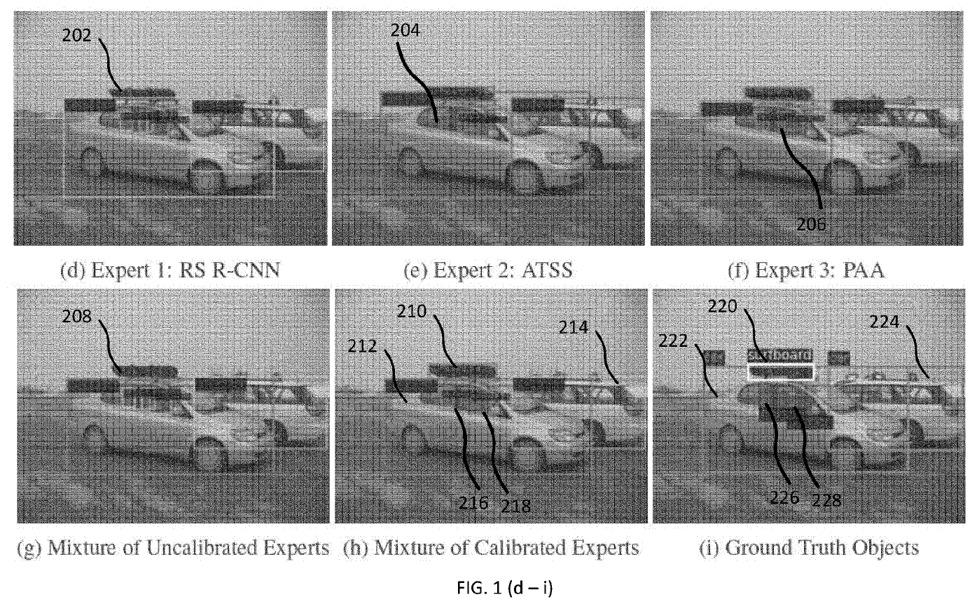

To illustrate this, FIG. 1(a) displays the confidence score distributions of RS R-CNN [52], a two-stage detector optimized by a ranking-based loss; ATSS [69], a one-stage detector obtaining the final confidence as the product of classification confidence and centerness [59]; and PAA [27] with the same architecture as ATSS but combining Intersection-over-Union (IoU) and classification confidence using geometric mean to obtain the final confidence. Due to these idiosyncrasies, the confidence score distributions of these detectors differ completely as shown in FIG. 1(a). The distribution of the uncalibrated, calibrated and target confidence cores on COCO [37] are shown. The detectors exhibit different distributions unless they are calibrated.

From FIG. 1 (a), it can be seen that around 60% of detections have a confidence score of around 0.45 for RS R-CNN (106), around 85% of detections have a confidence score of 0.1 for ATSS 102, and around 50% of detections have a confidence score of around 0.35 for PAA (104) respectively, and thus completely different. For example, RS R-CNN has significantly higher confidence than ATSSon the same subset of images. This renders utilising an MoE in a similar way a practitioner would use a DE infeasible, as the detector with the highest confidence will dominate the MoE, regardless of its accuracy.

FIG. 1(a) shows that RS R-CNN [52], using a ranking-based loss function, is the most confident detector while ATSS, combining the classification confidence with the centerness via multiplication, is the least confident one. Therefore, unless this miscalibration is addressed, an accurate MoE cannot be obtained for object detectors.

FIG. 1(b) shows distributions of the calibrated confidence scores for RS R-CNN, ATSS and PAA. From FIG. 1 (b), it can be seen that around 85% of detections have a confidence score of around 0.05 for RS R-CNN (108), around 75% of detections have a confidence score of around 0.1 for ATSS (110), and around 85% of detections have a confidence score of around 0.15 for PAA (112) respectively, and thus the confidence scores are much more similar in distribution when calibrated.

FIG. 1(c) shows distributions of the target confidence scores for RS R-CNN, ATSS and PAA. From FIG. 1 (b), it can be seen that around 80% of detections have a confidence score of around 0.05 for RS R-CNN (114), around 75% of detections have a confidence score of around 0.1 for ATSS (116), and around 95% of detections have a confidence score of around 0.15 for PAA (118) respectively, and thus the calibrated confidence scores in FIG. 1(b) are closer to the target confidence score distribution in FIG. 1(b) than the uncalibrated confidence score distributions in FIG. 1(a).

To address miscalibration and enable accurate MoEs, MOCAE provides a simple but effective method to address this problem and enable accurate MOEs for object detectors. At a high level, MOCAE combines post-hoc calibration methods such as Isotonic Regression (IR)[66] with a post-hoc approach for aggregation or clustering step which can be implemented by Non-Maximum Suppression (NMS) or its variants [1, 27].

Consequently, MOCAE now makes the confidence scores of the aforementioned detectors comparable as shown in FIG. 1(b,c). FIG. 1(d-i) presents the benefit of MOCAE on an example in which the same three detectors are combined, yielding the detections in FIG. 1(d-g). Note that the MoE of uncalibrated detectors in FIG. 1(g) is dominated by the most confident RS R-CNN with only one detection contribution from PAA and none from ATSS.

Specifically via calibration, the confidence is enforced to represent the Intersection-over-Union (IoU) of the detection with the object that it overlaps the most. This way of using IOU as the calibration target has two crucial benefits. First, if an object is detected by a single less confident detector, then the corresponding detection will be survived in the MoE as its confidence will be promoted to match its IoU. Secondly, for the objects detected by multiple detectors, NMS will choose the detection with the best IOU as it prioritizes the detections with respect to their confidence. FIG. 1(b) shows that calibration aligns the confidence of the detectors (with similar accuracy) to enable accurate MoEs by aligning them with the IoU depicted in FIG. 1(c).

FIG. 1(d-i) presents the benefit of calibration to obtain MoEs using the three detectors in (d-f). FIG. 1. (d-f) show outputs of the detectors on an example image. The example image comprises two cars, one with two persons in it and a surfboard on the roof of the car. In FIG. 1(d), RS R-CNN misses the “surfboard” 202. In FIG. 1(e), ATSS misses a “person” 204. In FIG. 1(f), PAA has a notable localisation error for the “person” 206 in front seat. FIG. 1 (g-i) show the detections from MoE of uncalibrated detectors; MoE of calibrated detectors; and the ground truth respectively; FIG. 1(g) is dominated by the most confident RS R-CNN and misses the “surfboard” 208. After calibration in FIG. 1(h), all objects (surfboard 210, car 212, car 214, person 216, person 218) are detected accurately by mitigating the errors of single detectors. FIG. 1(i) shows the ground truth objects: surfboard 220, car 222, car 224, person 226, person 228. The top-5 detections are plotted as there are 5 objects. Note that the MoE of uncalibrated detectors in FIG. 1(g) is dominated by the most confident RS R-CNN with only one detection contribution from PAA and none from ATSS. As a result, this MoE misses the “surfboard” and has a “person” as a false-positive (FP). After calibration, all detectors contribute to the MoE, which finally detects all objects accurately in FIG. 1(h). Besides, the resulting MoE is more accurate than the single detectors. This is because RS R-CNN (FIG. 1(d)) and ATSS (FIG. 1(e)) miss objects and PAA (FIG. 1(f)) has a notable localisation error for the “person” in the front seat.

It is shown that the incompatibility of confidence scores across different detectors is the main challenged to obtain accurate MoEs for object detection. To remedy this, MOCAE is proposed as an extremely simple, highly effective and principle method that combines post-hoc calibrators with aggregation approaches such as NMS or its variants.

It is shown that MOCAE performs much better than DEs even with fewer detectors in the mixture compared to that of in DEs. As an example, combining only ATSS and PAA using MOCAE outperforms DE with 5 components from either of these detectors.

MOCAE yields significant gain over the single models on different real world challenging detection tasks: (i) For object detection, MOCAE combining three strong detectors reaches 59.0 AP on COCO test-dev [43] with a gain of 2.4 AP compared to the best single model; (ii) for instance segmentation, MOCAE improves Mask R-CNN with ResNeXt-101 by 2.3 AP on the long-tailed LVIS dataset [20] with more than 1K object categories; (iii) for rotated object detection, 82.62 AP on DOTA dataset [56] as a new SOTA is obtained.

### Notations

Object Detection: Given that the set of M objects in an image X is represented by {bᵢ, cᵢ}^{M} where bᵢ∈ [symbol] ⁴ is a bounding box and cᵢ∈{1, . . . , K} its class; the goal of an object detector is to predict the bounding boxes and the class labels for the objects in X, ƒ(X)={ĉᵢ,\hat{b}ᵢ,\hat{p}ᵢ}^{N}, where ĉᵢ,\hat{b}ᵢ,\hat{p}ᵢ represent the class, bounding box and confidence score of the ith detection respectively and N is the number of predictions. In general, the detections are obtained in two steps,

$$f ( X ) = ( h ∘ g ) ( X ) [ 56 , 44 , 6 , 57 ] : where g ( X ) = {\{ {\hat{b}}_{i}^{raw} , {\hat{p}}_{i}^{raw} \}}^{{N}^{raw}}$$

is a deep neural network predicting raw detections with bounding boxes

$${\hat{b}}_{i}^{raw}$$

and predicted class distribution

$${\hat{p}}_{i}^{raw} .$$

Then, in the second step h(⋅) applies post-processing to raw-detections and the final detections are obtained. In general, h(⋅) consists of discarding the detections predicted as background; NMS to remove the duplicates; and keeping useful detections, normally achieved via top-k survival, where typically k=100 for COCO dataset.

Calibration of Object Detectors As extensively studied for classification, calibration refers to the alignment of accuracy and confidence of a model [19, 49, 30, 61, 47, 11]. Specifically, a classifier is said to be calibrated if it yields an accuracy of p on its predictions with a confidence of p for all p∈[0, 1]. Earlier definitions for the calibration of detectors [31, 48] extend this definition with an objective to align the confidence of a detector with its precision,

$$ℙ ( {\hat{c}}_{i} = {c}_{i} \vert {\hat{p}}_{i} ) = {\hat{p}}_{i} , ∀ {\hat{p}}_{i} ∈ [ 0 , 1 ] , \qquad ( 1 )$$

where [symbol] (ĉᵢ=cᵢ|\hat{p}ᵢ) denotes the precision as the ratio of correctly classified predictions among all detections. Extending from this definition, [54] takes into account that object detection is a joint task of classification and localisation. Thereby defining the accuracy as the product of precision and average IoU of true-positives (TPs), calibration of object detectors requires the following to be true

$$ℙ ( {\hat{c}}_{i} = {c}_{i} \vert {\hat{p}}_{i} ) {𝔼}_{{\hat{b}}_{i} ∈ {B}_{1} ( {\hat{p}}_{i} )} [ IoU ( {\hat{b}}_{i} , {b}_{ψ ( i )} ) ] = {\hat{p}}_{i} , ∀ {\hat{p}}_{i} ∈ [ 0 , 1 ] , \qquad ( 2 )$$

where Bᵢ(\hat{p}ᵢ) is the set of TPs with the confidence of \hat{p}ᵢ and b_{ψ(i)} is the object that \hat{b}ᵢ matches with. Then, Localisation-aware Expected Calibration Error (LAECE) is obtained by discretizing the confidence score space into J bins for each class. Specifically for class c, denoting the set of detections by [symbol] and those in the jth bin by [symbol] as well as the average confidence, precision and average IOU of

$${\hat{𝒟}}_{j}^{c} by {\overline{p}}_{j}^{c} ,$$

precision i^{c}(j) and IōU^{c}(j) respectively, LAECE for class c is defined as

$${LaECE}^{c} = {\sum }_{j = 1}^{J} \frac{\vert {\hat{𝒟}}_{j}^{c} \vert}{\vert {\hat{𝒟}}^{c} \vert} \vert {\overline{p}}_{j}^{c} - {precision}^{c} ( j ) \times {IoU}^{c} ( j ) \vert . \qquad ( 3 )$$

Finally, the detector LAECE is the average of LaECEcs over classes in the dataset, measuring the calibration error for a detector as a lower-better measure.

### Enabling Accurate Mixture of Experts Via Calibration

It is interesting to ask why the confidence score distributions vary significantly, despite the fact that the detectors perform similarly. Among different factors causing this incompatibility, one major factor is related to the architectures employed. For example, some recent detectors employ an additional auxiliary head to predict localisation confidence [59, 69, 25, 24, 27]. Then the final confidence is taken as an increasing function of classification and localisation confidences. Consequently, the auxiliary head choice such as centerness [59, 69] or IoU [25, 27] as well as the aggregation function such as multiplication [59, 69] or geometric mean [27] provides significant variation in the confidence scores. Architectural difference can also manifest itself in the type of the detector, which can be fully convolutional one-stage [69, 59], two-stage [56, 5], bottom-up [35, 14] as well as transformer-based detectors [6, 71]. Arguably, another factor causing the confidence incompatibility across the detectors is the used classifier, which commonly vary between a softmax [56, 6, 12, 2] or sigmoid classifiers for each class [69, 44, 27, 71]. Besides, following from the classifiers, different backbones [55], loss functions [47] and the training length [47, 54] affect the confidence of the model.

The Issue with Vanilla MoE

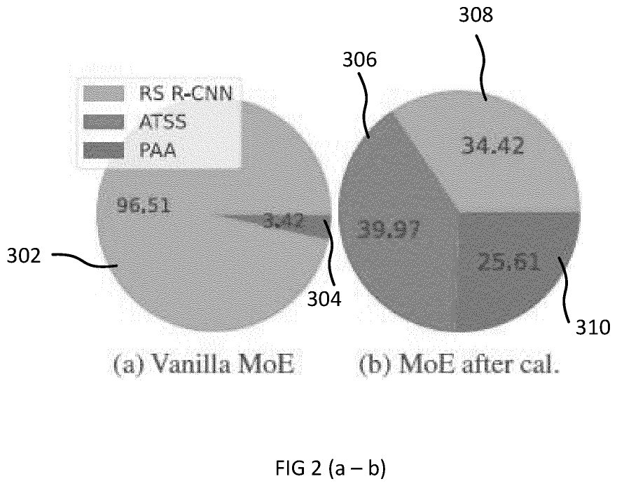

As the confidence scores of different detectors are incompatible, shown here, combining them naïvely does not yield a strong MoE. The most confident detector dominates the MoE regardless of its accuracy. To show this, similar to [7], a “Vanilla MoE” is constructed which aggregates the final predictions from RS R-CNN [52], ATSS [69] and PAA [27] using NMS. FIG. 2 shows pie charts representing the % of detections obtained from a certain detector in the final detection set of MoEs. FIG. 2(a) shows a pie chart representing the % of detections obtained from Vanilla MoE (uncalibrated detectors). It can be seen from FIG. 2(a) that 96.51% of detections are obtained from RS R-CNN (sector 302 of pie chart), and 3.42% of detections are obtained from PAA (sector 304 of pie chart). FIG. 2(a) shows that Vanilla MoE is dominated by the most confident RS R-CNN (following the setting in FIG. 1(a)) with a small contribution from less confident PAA and almost no detections from the least confident ATSS. FIG. 2(b) shows a pie chart representing the % of detections obtained from MoE of calibrated detectors. It can be seen from FIG. 2(b) that 39.97% of detections are obtained from ATSS (sector 306 of pie chart), 34.42% of detections are obtained from RS R-CNN (sector 308 of pie chart), and 25.61% of detections are obtained from PAA (sector 310 of pie chart). As a result, while one would expect an MoE to detect more objects than individual detectors and obtain a better recal. Tab. 1(bottom) shows the opposite.

Tab. 1 and FIG. 2 provide an example by using the same three detectors from FIG. 1: RS R-CNN [45], ATSS [62] and PAA [24]. The LAECE is first quantified before calibration in Tab. 1(top) and observe that RS R-CNN is the most confident one, which is followed by PAA and ATSS respectively. Now the detections of these detectors are combined simply by NMS without calibration. This method is referred to as “Vanilla MOE”, which yields a lower Average Recall (AR) compared to ATSS and PAA.

FIG. 2(a) shows that Vanilla MoE is dominated by the most confident RS R-CNN with a small contribution from less confident PAA and almost no detections from the least confident ATSS. Consequently, while one would expect a MoE to detect more objects than single detectors and obtain a better recall, Tab. 1(bottom) shows the opposite; Vanilla MoE yields a lower AR compared to ATSS and PAA. It is argued that this effect is fundamentally down to the miscalibration of the detectors.

TABLE 1
(Top) L_{A}ECE of detectors before and after calibration (cal.). (Bottom)
Recall@IOU (R@IoU) and AR using 100 detections.

| Calibration | RS-RCNN | ATSS | PAA |
|---|---|---|---|
| x | 36.45 | 5.01 | 11.23 |
| ✓ | 3.15 | 4.51 | 1.62 |
| Method | R@0.50 | R@0.75 | AR |
| RS R-CNN | 83.2 | 62.7 | 58.3 |
| ATSS | 83.1 | 65.9 | 60.8 |
| PAA | 83.4 | 65.8 | 61.1 |
| Vanilla MoE | 83.6 | 64.1 | 59.7 |
| MoE after cal. | 85.1 | 67.7 | 62.3 |

The aforementioned issue clearly indicates that naïvely obtaining MoE will normally be biased and lead to an ineffective mixture.

A fundamental issue with constructing an MoE, is that a situation can often arise when one of the detector dominates the predictions. However, this is not necessarily a deficiency, as one would expect an accurate detector to dominate the predictions when combined with inaccurate ones. The question naturally arises as to what the appropriate contribution from each detector is in the final output. Conceptually, the MoE should combine predictions based on their performance, which can be inferred through the confidence estimates provided at test time. However, these confidence estimates are typically unaligned with the models performance, a pathology known as miscalibration. Consequently, to appropriately combine detectors, they are first calibrated individually, enabling reliable contributions from each detector. LAECE is reported in 136 Tab. 1 (top) where it can be seen that RS-RCNN has the largest LAECE, indicating that its contribution to the Vanilla MoE is not based on its performance.

### Introducing MOCAE

Motivated from this example, this issue is addressed and MoEs with appropriate contributions are obtained from the individual detectors. To do this, MOCAE is introduced that (i) solves this incompatibility issue via calibrating the confidence scores, and (ii) filters out the duplicates from different detectors and refines the detections to have a higher IoU. MOCAE first calibrates the confidence of each detector to properly prioritize the detections from different detectors. Second, these detections from different detectors are clustered and gated using stronger NMS methods to make the most of multiple high quality detections. While extremely simple, MOCAE results in significant gains over the single detectors in the MoE.

### Appropriate Choice of Calibration Function

Having identified the issue with the Vanilla MoE, the question naturally arises as to how to calibrate the single detectors to address this deficiency. As opposed to the standard classification task, object detection jointly solves both classification and regression tasks; and also involves various post processing steps that can influence the accuracy of the detector. Therefore, it is not straightforward as to what objective the final calibrator should have and at which stage of the pipeline it should be applied. Here, it is aimed to choose a calibration target which is useful for the clustering step. A natural choice would be to calibrate the scores such that it helps the most crucial aggregation stage (e.g., NMS). This stage does not require training and practically has significant impact on the performance of a detector.

For simplicity, the standard NMS is considered, which groups the detections that have an IoU with the maximum-scoring detection larger than a predefined IoU threshold. Then, within that group, NMS survives the detection with the largest score and removes the remaining detections from the detection set. In such a setting, as also discussed by the recent works [38, 37, 26, 25, 69], the ideal confidence that should be transferred to the NMS is arguably the IOU of the detection with the object. This will help NMS to pick accurately-localised detections for the objects detected by multiple detectors. Also, if an object is detected by a single less confident detector, aligning the confidence with IoU implies that the scores of the TPs are to be promoted. Thus, the TPs of a less confident detector will not be dominated by the FPs of more confident ones unlike the case in FIG. 2(a).

Following this intuition, a detector is said to be calibrated if it yields a confidence that matches the IoU:

$${𝔼}_{{\hat{b}}_{i} ∈ {B}_{i} ( {\hat{p}}_{i} )} [ IoU ( {\hat{b}}_{i} , {b}_{ψ ( i )} ) ] = {\hat{p}}_{i} ∀ {\hat{p}}_{i} ∈ [ 0 , 1 ] , \qquad ( 4 )$$

where Bᵢ(\hat{p}ᵢ) is the set of detection boxes with the confidence score of \hat{p}ᵢ and b_{ψ(i)} is the ground-truth box that \hat{b}ᵢ has the highest IoU with. Note that this corresponds to using an IoU threshold of 0 to validate TPs. Hence, LAECE is used by setting precision ^{c}(j)=1 in Eq. (3).

### Choice of Calibration Method

There are multiple post-hoc calibration methods [19, 29], so the following are investigated: Linear Regression (LR) and IR [66] considering the criterion in Eq. (4). It is observed that training a Class-agnostic (CA) IR calibrator for each detector on 500 images is sufficient to enable MoEs. Using the same example in Tab. 1 and FIG. 2, the positive effect of calibration can easily be seen; LAECE significantly decreases in Tab. 1(top), which enables an MoE with a significantly better AR than the single detectors in Tab. 1(bottom). This is achieved since all detectors contribute to the MoE in a more balanced way after calibration as shown in FIG. 2(b).

### Late or Early Calibration

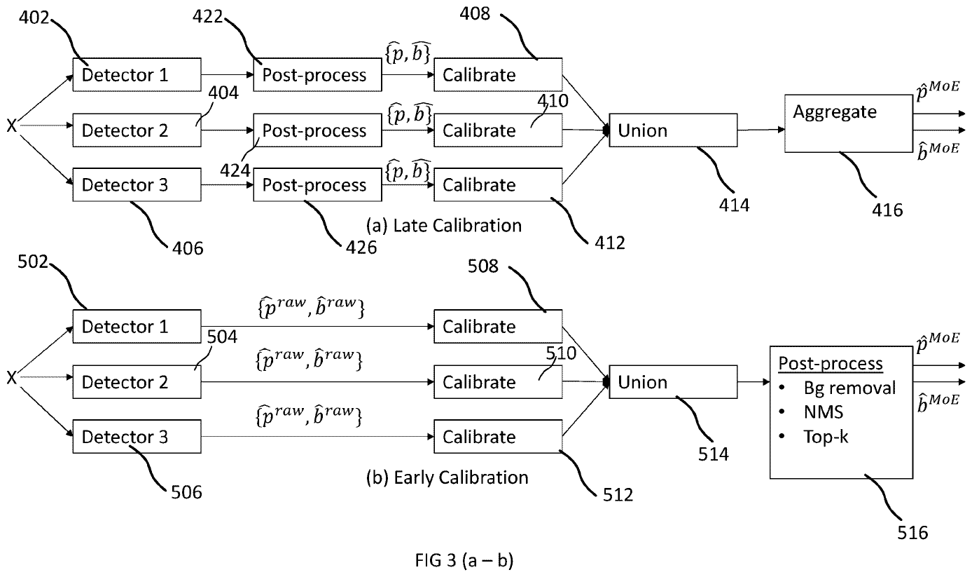

FIG. 3(a) shows a schematic block diagram of a late calibration architecture for object detection. FIG. 3(a) shows in this example first, second and third detectors 402, 404, 406. Whilst three detectors are considered, the technical can be applied with any number of detectors. The first detector 402 has an output coupled to an input of a first post-processing component 422. The second detector 404 has an output coupled to an input of a second post-processing component 424. The third detector 406 has an output coupled to an input of a third post-processing component 426. The first detector 402 has an output that is calibrated in step 408. The second detector 404 has an output that is calibrated in step 410. The third detector 406 has an output that is calibrated in step 412. The outputs of steps 408, 410, and 412 are concatenated in step 414. Step 414 has an output which is aggregated in step 416.

In FIG. 3(a), the post processing and calibration for the multiple detectors may be performed in parallel or sequentially. With sequential processing, a single post-processing component may be used to perform post-processing on the detections sequentially.

In FIG. 3(a) illustrates, each detector (402, 404, 406) follows its own pipeline and outputs {\hat{p}, \hat{b}} as top-k detections. The confidence scores of final detections \hat{p} are first calibrated (steps 408, 410, 412), then aggregated (in step 416) via NMS or its variants. The top-k is obtained as the detections of MoE {\hat{p}^{MoE}, \hat{b}^{MoE}}. The confidence of final detections \hat{p} are first calibrated, then the detections are concatenated (step 414), and duplicates from different detectors are suppressed in the clustering step.

FIG. 3(b) shows a schematic block diagram of an early calibration architecture for object detection. FIG. 3(b) shows in this example first, second and third detectors 502, 504, 506. Whilst three detectors are considered, the technical can be applied with any number of detectors. The first detector 502 has an output that is calibrated in step 508. The second detector 504 has an output that is calibrated in step 510. The third detector 506 has an output that is calibrated in step 512. The outputs of steps 508, 510, and 512 are concatenated in step 514. Step 514 has an output which processed in step 516.

In FIG. 3(b) raw confidence scores \hat{p}^{raw} from detectors 502, 504 and 506 are calibrated (in steps 508, 510, 512), and the standard post-processing steps (516) handle aggregation in which NMS removes the duplicates from multiple detectors. \hat{p}^{MoE} and \hat{b}^{MoE} represent the predicted confidence score and bounding boxes from the MoE.

Up to now, calibrating final confidence scores \hat{p}ᵢ similar to [31, 54] has been discussed, shown as late calibration in FIG. 3(a). Besides, the effectiveness of early calibration is also investigated by calibrating the raw probabilities

$${\hat{p}}_{i}^{raw}$$

of the detectors as illustrated in FIG. 3(b). While it is found that both approaches perform similar in MoEs, late calibration is used as it is more simple owing to the less number of final detections. Still, as the first to investigate early calibration, an additional use-case of early calibration is demonstrated later in which it reduces the sensitivity of the model to the background removal threshold in post-processing in terms of accuracy and efficiency.

### Aggregating Calibrated Detections

Given calibrated detections from different detectors (FIG. 3), it is aimed to suppress redundant detections targeting the same object and obtain detections with high localisation quality (extracting detections with a high IoU). As afore-mentioned, NMS is a method that fits for this purpose and, as observed experimentally, does provide highly competitive results. Alternatively, Refining NMS is constructed that simply combines Soft NMS [1] with Score Voting [27]. Soft NMS, by design, is less rigid in removing overlapping detections. Instead, it decreases the scores of overlapping boxes that naturally leads to improved recall. Score Voting combines multiple overlapping detections (using their confidences and IoU s with each other) and obtains a refined detection with better localisation. Thus, combining these two approaches leads to a much effective aggregator.

### Experiments

The benefit of MOCAE on three different tasks is presented, namely: object detection, instance segmentation and rotated object detection. For these tasks, a total of 11 different detectors are used; these architectures are very diverse and include one-stage and two-stage convolutional as well as transformer-based ones. The experiments clearly demonstrate that calibration is essential to enable accurate MoEs. Specifically, MOCAE improves (i) three strong object detectors on COCO test-dev by 2.4 AP by reaching 59.0 AP; (ii) instance segmentation methods on the challenging long-tailed LVIS dataset by 2.3 AP; and (iii) all existing rotated object detectors by reaching 82.62 AP₅₀ on DOTA dataset, establishing a new SOTA. Also, MOCAE yields significant gain compared DEs, even in situation where the number of experts is far fewer than the number of ensemble components. Also, MoEs obtained by MOCAE approach yield significant gain compared to single models and DEs. These gains are still maintained on strong detectors and challenging datasets such as the long-tailed LVIS.

### MOCAE for Object Detection

Dataset and Performance Measures: For object detection the common COCO dataset [43] is used as a common benchmark. Similar to [32], COCO val set is randomly split with 5K images into two, and use 2.5K images as COCO minimal to calibrate the detectors and keep the remaining 2.5K images for testing as COCO minitest. COCO test-dev with 20K images is used as a large-scale test set by submitting results to the evaluation server. For evaluation, COCO-style Average Precision (AP) is mainly used and also the following ate reported (i) AP₅₀, AP₇₅ as the APs measured at IOU thresholds 0.50 and 0.75; as well as (ii) APS, AP_{M} and AP_{L} to present the accuracy on small, medium and large objects.

Used Detectors: MoEs in two different settings are obtained using off-the-shelf detectors. First the following are employed: RS R-CNN, ATSS and PAA with ResNet-50 [21] with FPN [41] backbone. As previously discussed, they have different characteristics making these detectors non-trivial to combine:
Rank & Sort R-CNN (RS R-CNN) is a recent representative of the two-stage R-CNN family optimizing a ranking-based loss function.
Adaptive Training Sample Selection (ATSS) is a common one stage baseline,
Probabilistic Anchor Assignment (PAA) [24] relies on the one-stage ATSS architecture but with a different anchor assignment mechanism and postprocessing of the confidence scores.

Second, to see if the gains generalize to a challenging case, the following detectors are selected, which are among the most strong publicly available ones on COCO dataset:
YOLOv7 [60] with a large convolutional backbone following its original setting,
QueryInst [17] as a transformer-based detector with a Swin-L [45] backbone,
ATSS with transformer-based dynamic head [13] and again Swin-L backbone.

Calibration is crucial for accurate MoEs: The importance of calibration in obtaining strong MoEs is demonstrated. To do so, three MoEs are constructed from pair-wise combinations of RSR-CNN, ATSS and PAA as well as one MoE that combines all three. In order to focus only on calibration, the standard NMS with an IoU threshold of 0.65 is used as in [60]. Tab. 2 presents the results of MoEs with uncalibrated and calibrated detectors.

TABLE 2
Effect of calibration on MoE performance. All MoEs use Late calibration with
standard NMS. While combining uncalibrated detectors do not provide notable
gain over the single detectors, calibration is essential for a strong MoE
resulting in up to ~1.5 AP gain over single detectors.

| | | Combined Detectors | | | Object Detection Performance | | | | | |
|---|---|---|---|---|---|---|---|---|---|---|
| Model Type | Calibration | RS R-CNN | ATSS | PAA | AP | AP₅₀ | AP₇₅ | AP_{S} | AP_{M} | AP_{L} |
| Single Models | N/A | ✓ | | | 42.4 | 62.1 | 46.2 | 26.8 | 46.3 | 56.9 |
| | N/A | | ✓ | | 43.1 | 61.5 | 47.1 | 27.8 | 47.5 | 54.2 |
| | N/A | | | ✓ | 43.2 | 60.8 | 47.1 | 27.0 | 47.0 | 57.6 |
| Mixtures of | x | ✓ | ✓ | | 42.4 | 62.1 | 46.3 | 26.8 | 46.3 | 56.9 |
| Experts | ✓ | ✓ | ✓ | | 44.1 | 63.0 | 48.4 | 28.5 | 48.4 | 56.8 |
| | x | ✓ | | ✓ | 43.4 | 62.5 | 47.1 | 27.3 | 47.3 | 58.0 |
| | ✓ | ✓ | | ✓ | 44.0 | 62.7 | 47.9 | 28.2 | 48.2 | 58.1 |
| | x | | ✓ | ✓ | 43.3 | 60.9 | 47.2 | 27.1 | 47.2 | 57.6 |
| | ✓ | | ✓ | ✓ | 44.4 | 62.5 | 48.5 | 29.2 | 48.5 | 57.3 |
| | x | ✓ | ✓ | ✓ | 43.4 | 62.5 | 47.1 | 27.3 | 47.3 | 58.0 |
| | ✓ | ✓ | ✓ | ✓ | 44.7 | 63.1 | 48.9 | 29.2 | 49.0 | 58.2 |

The striking observation is that without calibration, the MoEs perform similar to the single models and calibration enables strong MoEs for all four settings. Specifically, using two calibrated MoEs boosts the performance by ~1AP and using three by 1.5AP compared to single models; showing the effectiveness of calibration. Even with less models, MOCAE performs better than DEs Next MOCAE, Vanilla MoE and DEs are compared. Similar to MOCAE, DEs are obtained by using late calibration with Refining NMS for aggregation. Tab. 3 shows that the DEs perform consistently better than the single models; validating them as strong baselines. The striking observation is that without calibration, the resulting MoE performs similar to the single models and calibration consistently enables strong MoEs for object detection for all four MoEs. Specifically, among MoEs combining two detectors, while the best AP without calibration is 43.4, calibration boosts it to 44.4. Besides, while the MoE from three uncalibrated detectors performs similar with the single detectors, calibration enables it to achieve the best result with 44.7 AP. Therefore, 1.5 AP gain over the best single model demonstrates the benefit of calibration to obtain accurate MoEs.

TABLE 3
Comparison of our M_{O}C_{A}E with DEs and Vanilla MoE. MoEs
obtained by our M_{O}C_{A}E outperforms DEs significantly even
with less detectors. Our gains are obtained compared to the best
single model for each performance measure, represented as
underlined.

| Model | | | | | | | |
|---|---|---|---|---|---|---|---|
| Type | Detector | AP | AP₅₀ | AP₇₅ | AP_{S} | AP_{M} | AP_{L} |
| Single | RS R-CNN | 42.4 | 62.1 | 46.2 | 26.8 | 46.3 | 56.9 |
| Models | ATSS | 43.1 | 61.5 | 47.1 | 27.8 | 47.5 | 54.2 |
| | PAA | 43.2 | 60.8 | 47.1 | 27.0 | 47.0 | 57.6 |
| Deep | RS R-CNN × 5 | 44.5 | 63.0 | 49.1 | 28.8 | 48.6 | 58.4 |
| En- | ATSS × 5 | 44.1 | 62.4 | 48.0 | 29.7 | 48.6 | 56.2 |
| sembles | PAA × 5 | 44.5 | 62.3 | 48.3 | 28.6 | 48.7 | 59.3 |
| Mix- | Vanilla MoE | 44.4 | 62.6 | 48.2 | 27.8 | 48.4 | 59.3 |
| tures | with Ref. | | | | | | |
| of | NMS (RS R- | | | | | | |
| Ex- | CNN, | | | | | | |
| perts | ATSS, PAA) | | | | | | |
| | M_{O}C_{A}E | 44.8 | 62.4 | 49.2 | 29.4 | 49.1 | 57.6 |
| | (ATSS and | | | | | | |
| | PAA) - Ours | | | | | | |
| | M_{O}C_{A}E (RS | 45.5 | 63.2 | 50.0 | 29.7 | 49.7 | 59.3 |
| | R-CNN, | | | | | | |
| | ATSS, PAA) - | | | | | | |
| | Ours | | | | | | |
| | | +2.3 | +2.1 | +2.9 | +1.9 | +2.2 | +1.6 |

To obtain DEs and MoEs, we use late calibration with NMS+ to compare them in their best setting. Tab. 3 shows that the resulting DEs perform consistently better than the single models; validating them as stronger baselines. The main observation in Tab. 3 is that combining different types of few detectors into an MoE performs significantly better than DEs. Specifically, MOCAE with only two detectors, ATSS and PAA, outperforms all DEs with five components. Also, combining three detectors by MOCAE performs 1 AP better than its closest counterpart DE. This is because the same type of detectors make similar errors, which yields less gain once they are combined together. However, different types of detectors complement each other thanks to their diversity. Finally, MOCAE outperforms Vanilla MOE using uncalibrated detectors by 1.1 AP in this stronger setting with Refining NMS as well. Our final model obtains 45.5 AP and outperforms the best single model in all AP variants significantly by between 2-3 AP. It is hypothesized that this is because the same type of detectors make similar errors, which yields less gain once they are combined together. Conversely, different types of detectors complement each other more thanks to their diversity in architecture, loss function, anchor assignment mechanism.

The gain of MOCAE generalizes to strong object detectors on COCO test-dev. Until now smaller scale (but recently-proposed) detectors have been used. Considering that the performance gain tends to decay in stronger settings, it is now investigated how MOCAE performs in such a setting using COCO test-dev. As previously described, here the following are obtained: an MoE from YOLOv7, QueryInst and ATSS with dynamic head, which are among the most accurate publicly available detectors. These detectors differ from each other in terms of the pretraining data, backbone or architecture as summarized in Tab. 4.

TABLE 4
Object detection performance on COCO test-dev and mini-test using strong object
detectors. The gains are reported compared to the best single model as underlined.
M_{O}C_{A}E maintains the significant AP boost also for this challenging setting as well.

| | Pretraining | Back- | COCO test-dev | | | | | | COCO minitest | | | | | |
|---|---|---|---|---|---|---|---|---|---|---|---|---|---|---|
| Method | Data | bone | AP | AP₅₀ | AP₇₅ | AP_{S} | AP_{M} | AP_{L} | AP | AP₅₀ | AP₇₅ | AP_{S} | AP_{M} | AP_{L} |
| YOLOV7 | None | L-size | 55.5 | 73.0 | 60.6 | 37.9 | 58.8 | 67.7 | 55.6 | 73.1 | 60.6 | 41.2 | 60.4 | 69.5 |
| [60] | | conv. | | | | | | | | | | | | |
| Query Inst | None | Swin- | 55.7 | 75.7 | 61.4 | 36.2 | 58.4 | 70.9 | 55.9 | 75.4 | 61.3 | 38.5 | 60.8 | 73.2 |
| [17] | | L | | | | | | | | | | | | |
| DyHead | ImageNet22K | Swin- | 56.6 | 75.5 | 61.8 | 39.4 | 59.8 | 68.7 | 56.8 | 75.6 | 62.2 | 42.8 | 60.6 | 71.0 |
| [13] | | L | | | | | | | | | | | | |
| Vanilla | N/A | N/A | 57.6 | 76.6 | 63.2 | 40.0 | 60.9 | 70.8 | 57.7 | 76.3 | 62.9 | 42.6 | 62.7 | 72.8 |
| MOB | | | +1.0 | +0.9 | +1.4 | +0.6 | +1.1 | −0.1 | +0.9 | +0.7 | +0.7 | −0.2 | +1.9 | −0.4 |
| M_{O}C_{A}E | | N/A | 59.0 | 77.2 | 64.7 | 41.1 | 62.6 | 72.4 | 58.9 | 76.8 | 64.3 | 44.7 | 63.6 | 74.1 |
| (Ours) | | | +2.4 | +1.5 | +2.9 | +1.7 | +2.8 | +1.5 | +2.1 | +1.1 | +2.1 | +1.9 | +2.8 | +1.1 |

It is observed that the MOCAE reaches 59.0 AP with a gain of 2.4 AP gain on this challenging setting as well. Thereby demonstrating the effectiveness of MOCAE on strong detectors.

### MOCAE for Other Detection Tasks

The benefit of MOCAE for instance segmentation and rotated object detection is shown.

Instance Segmentation: LVIS [20] is used as a long-tailed dataset for instance segmentation with more than 1K classes. Following its standard evaluation, the AP on rare (APr), common (APc) and frequent (APf) classes are reported. Similar to COCO, 500 images are reserved from LVIS val set to calibrate the detectors, and test the models on the remaining 19.5K images of the val set. Three recent and diverse off-the-shelf Mask R-CNN variants are combined in a MOE:
The vanilla Mask R-CNN [22] with ResNeXt-101 [64] backbone, softmax classifier and 250 using Repeat Factor Sampling (RFS) to address the long-tailed nature of LVIS,
Mask R-CNN with ResNet-50, sigmoid classifier, trained with RS Loss [52] and RFS,
Mask R-CNN with ResNet-50, softmax classifier, trained with Seesaw Loss[62] but no RFS.

TABLE 5
Instance segmentation performance on LVIS val set. Seesaw
Loss and RS Loss also use Mask R-CNN. While Vanilla
MoE does not improve AP compared to the best single
detector (underlined), MOCAE yields 2.3 AP gain over
single detectors. APbox represents detection AP.

| Method | AP | AP₅₀ | AP₇₅ | APᵣ | AP_{c} | AP_{f} | AP_{box} |
|---|---|---|---|---|---|---|---|
| Mask R- | 25.4 | 39.2 | 27.3 | 15.7 | 24.7 | 30.4 | 26.6 |
| CNN | | | | | | | |
| [22] | | | | | | | |
| RS Loss | 25.1 | 38.2 | 26.8 | 16.5 | 24.3 | 29.9 | 25.8 |
| [52] | | | | | | | |
| Seesaw | 25.4 | 39.5 | 26.9 | 15.8 | 24.7 | 30.4 | 25.6 |
| Loss | | | | | | | |
| [62] | | | | | | | |
| Vanilla | 25.2 | 38.3 | 26.8 | 16.5 | 24.3 | 29.9 | 25.9 |
| MOE | −0.2 | −1.2 | −0.5 | 0.0 | −0.4 | −0.5 | −0.7 |
| M_{O}C_{A}E | 27.7 | 42.8 | 29.4 | 18.2 | 27.3 | 32.4 | 29.1 |
| (Ours) | +2.3 | +3.3 | +2.1 | +1.7 | +2.4 | +2.0 | +2.5 |

Tab. 5 shows that while the Vanilla MoE performs worse than the best single model, the MoCAE boosts the segmentation AP by 2.3. This is again significant improvement as it corresponds to ~10% relative gain compared to the best model. Also, the detection AP (APbox) improves by 2.5 aligned with the previous findings. Finally, MoCAE outperforms the single models in terms of all AP variants (e.g., APr), thereby enabling a strong MoE in which the detectors complement each other as desired.

Rotated Object Detection: MOCAE is now investigated for rotated object detection on DOTA v1.0 dataset [63] with 15 classes. DOTA is also a challenging dataset comprising of aerial images with 67.1 objects on average. All 458 images are used in the val set to calibrate the detectors and report AP₅₀ on the test set by submitting the results to the evaluation server. LSKN [40] as the current SOTA and RTMDet [46] as two recent detectors are combined. Following the literature, we use NMS with an IoU threshold of 0.35 as Soft NMS and Score Voting are not straightforward to use in this task.

TABLE 6
Rotated object detection performance on DOTA test set.
AP₅₀ is used following DOTA. M_{O}C_{A}E outperforms
previous SOTA as it mainly improves the classes where
the detectors have the lowest AP₅₀.

| | | 5 Classes with Lowest Performance | | | | |
|---|---|---|---|---|---|---|
| Method | AP₅₀ | Bridge | Soccer | Roundab. | Harbor | Helico. |
| RTMDet | 81.32 | 58.50 | 72.12 | 70.85 | 81.16 | 77.24 |
| [46] | | | | | | |
| LSKN | 81.85 | 61.47 | 71.67 | 71.35 | 79.19 | 80.85 |
| [40] | | | | | | |
| Vanilla | 80.60 | 61.77 | 70.98 | 65.92 | 84.28 | 77.57 |
| MoE | −1.25 | +0.30 | −1.14 | −5.43 | +3.12 | −3.28 |
| MOCAE | 82.62 | 61.38 | 75.50 | 74.12 | 84.49 | 81.93 |
| (Ours) | +0.77 | -0.09 | +3.38 | +2.77 | +3.33 | +1.08 |

Tab. 6 suggests to establish a new SOTA with 82.62 AP50 on DOTA; improving the previous SOTA by 0.77. Having examined the classes, it is noted that the improvement originates mostly from the classes with relatively lower performance. For example, on ‘soccer-field’, ‘roundabout’, ‘harbor’ classes where the single detectors have between 70-80 AP₅₀, the gain is around 3 AP₅₀. These gains enable the demonstration of the ability of MOCAE to set a new SOTA in rotated object detection.

### Further Analyses and Discussions

Validating the Calibrator: It is first justified why Class-agnostic (CA) IR calibrator is preferred in MOCAE. Ideally, it is expected for a calibrator to improve the calibration also by preserving the accuracy of the detector. To see that, LR and IR both CA and Class-wise (CW) are investigated on late as well as early calibration in Tab. 7.

It is observed that in Tab. 7 that all calibrators, except CA IR, decrease AP especially for early calibration. Furthermore, CA IR improves LAECE in all cases. CA IR improves average and maximum calibration errors; thereby providing a better gain for MoEs compared to other calibrators. These observations on accuracy and calibration led CA IR to be chosen while calibrating the single models in MoCAE.

Ablation Analysis Further ablation of MoCAE is provided in Tab. 8.

TABLE 8
Ablation analysis of MoCAE. The MOE is used combining RS R-CNN,
ATSS and PAA on COCO mini-test. Calibration, either early or
late, yields the major improvement, Soft NMS contributes slightly
and Score Voting has a notable effect on the performance.

| Cal. | | Refining NMS | | |
|---|---|---|---|---|
| Type | Calibration | Soft NMS | Score Voting | AP |
| Early | x | x | x | 43.3 |
| Early | ✓ | x | x | 44.5 |
| Late | ✓ | x | x | 44.7 |
| Late | ✓ | ✓ | x | 44.8 |
| Late | x | ✓ | x | 43.4 |
| Late | ✓ | ✓ | ✓ | 44.4 |
| Late | ✓ | ✓ | ✓ | 45.5 |

Note that regardless of early or late, calibration appears to be the major factor of the performance gain. Seeing that the late calibration performs slightly better than early (44.7 vs. 44.5) and it is simpler to implement, late calibration is used in MOCAE. More results comparing early and late calibration are presented later. Tab. 8 shows that Soft NMS yields a small gain of 0.1 AP and Score Voting, combining boxes from different detectors to extract a new bounding box, improves AP notably from 44.8 to 45.5.

Early calibration reduces the sensitivity to background removal threshold. Before concluding, an additional use-case of early calibration is investigated in which it reduces the sensitivity of the detectors to background removal threshold in terms of both AP and efficiency. As AP provably benefits from more detections [54], detectors prefer a small background removal threshold as the first step of post-processing (FIG. 3(b)). To illustrate, 0.05 is the common choice for COCO [69, 27, 56] and it is as low as 10-4 for LVIS [8, 20]. While this convention is preferred by AP, it can easily increase NMS processing time especially for over-confident detectors. This is because, for such detectors, the background removal step accepts redundant true-negatives (TNs), which should have been rejected unless the threshold is set properly. Hence, due to this large number of redundant TNs propagated to the NMS, NMS processing time significantly increases. To illustrate on PAA, which uses a threshold of 0.05 for COCO, NMS takes 29.2 ms/image on a Nvidia 1080Ti GPU, while it only takes ~0.6 ms/image for ATSS and Faster R-CNN (F R-CNN).

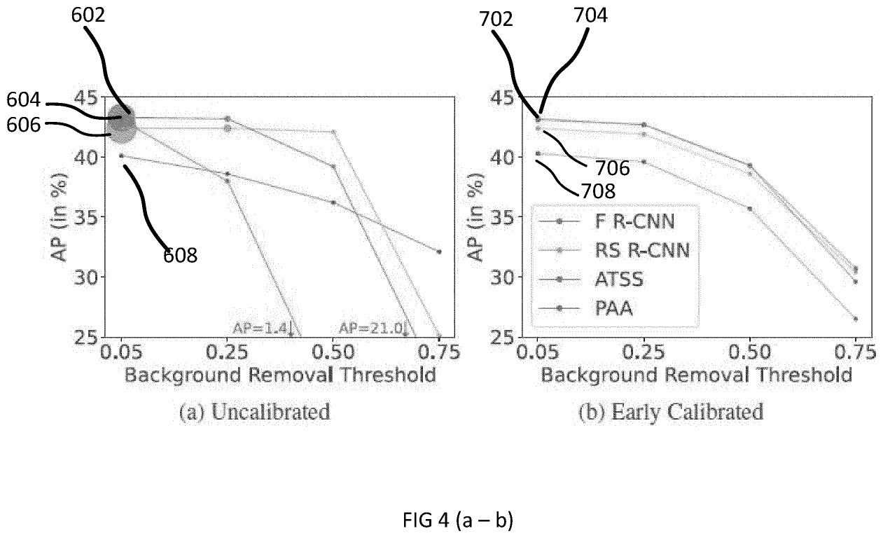

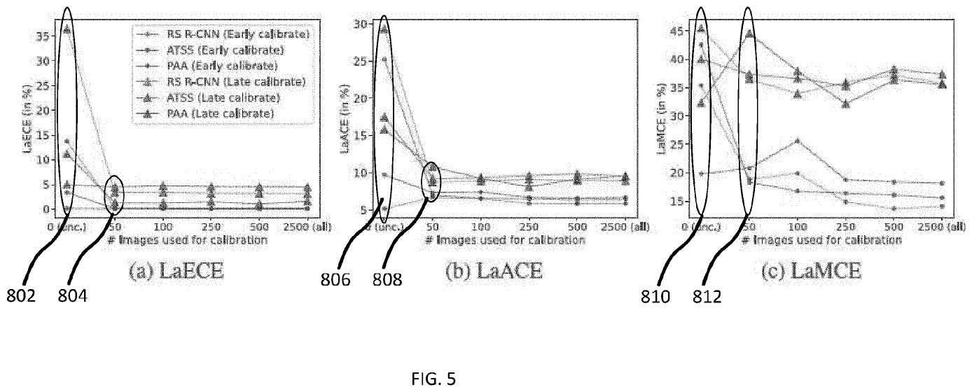

FIG. 4 shows the effect of background removal threshold on AP and NMS processing time for (a) uncalibrated and (b) early calibrated detectors on COCO. This difference among the detectors can easily be noticed by comparing the areas of the dots at 0.05 in FIG. 4(a). The area of the dots are proportional to the NMS processing time of the detectors. The dot 602 corresponds to PAA, the dot 604 corresponds to ATSS, the dot 606 corresponds to RS R-CNN, and the dot 608 corresponds to F R-CNN. Common background removal threshold is 0.05 for the detectors in which case PAA and RS R-CNN have large (bigger dots) NMS processing time in FIG. 4(a). Also, once uncalibrated, the detectors follow different trends and are sensitive to background removal threshold in terms of AP and NMS processing time. In FIG. 4(b), early calibration (i) aligns the detector by reducing this sensitivity, and (ii) allows using 0.05 by both maximizing the AP and reducing NMS processing time for the over-confident PAA and RS R-CNN. As seen from FIG. 4(b), the dots for PAA (702), ATSS (704), RS R-CNN (706), and F R-CNN (708) are now all of a similar area. This shows that the NMS processing time for PAA and RS R-CNN has been reduced after calibration compared to FIG. 4(a) without calibration.

Specifically, it is observed for PAA that ~45K 297 detections are propagated to the NMS per image on average. After early calibration, this number of detections from the same threshold reduces to ~2K per image, which now enables NMS to take only 0.8 ms/image as ideally expected. FIG. 4(b) presents that NMS takes consistently between 0.6 to 0.8 ms/image for all detectors as the behaviour of the detectors are aligned.

In one example, each detector processes the input in parallel, meaning the overhead introduced by MOCAE would be negligible when a separate GPU is allocated for each detector. Besides, comparing FIG. 2(b) with FIG. 2(a), it was shown that calibration balances the contribution of the detectors to MoE. However, PAA, as the most accurate detector, has still the lowest contribution with %25.61 in FIG. 2(b). This is because LAECE after calibration in Tab. 1(Top) is still non-zero for the detectors. Therefore, better calibration methods could give rise to more accurate MoEs.

### Further Details on Refining NMS

As described above, Soft NMS is combine with Score Voting while aggregating the detections of different detectors in our MOCAE approach. Here, for the sake of completeness, these approaches are presented. Starting with the standard NMS and providing some background information: given a set of raw detections after background removal, the standard NMS first selects the maximum scoring detection {\hat{b}_{α},\hat{p}_{α}} and then groups the detections that have an IoU with {\hat{b}_{α},\hat{p}_{α}} larger than a predefined IoU threshold. Considering the common usage of NMS, it is assumed that NMS operates class-wise. Hence, the predicted class label is not explicitly included in the detection representation. Then, NMS survives {\hat{b}_{α},\hat{p}_{α}} by placing it to the final detection set and discards all other raw detections from that group assuming that they are duplicates. This process takes place until all raw detections are either moved to the final detection set or discarded. Instead of removing the detections (i.e., the detections other than {\hat{b}_{α},\hat{p}_{α}} completely, Soft NMS decreases their confidence scores as a function of their overlap with {\hat{b}_{α},\hat{p}_{α}}. More specifically, Soft NMS has two variants determined by the type of this rescoring function. The first one is called Linear Soft NMS, in which the confidence scores are rescored such that

$${\hat{p}}_{i} = \{ \begin{matrix}{\hat{p}}_{i} & if IoU ( {\hat{b}}_{i} , {\hat{b}}_{α} ) < {IoU}_{NMS} \\ {\hat{p}}_{i} \times ( 1 - IoU ( {\hat{b}}_{i} , {\hat{b}}_{α} ) ) & else\end{matrix} , \qquad ( A \text{.5} )$$

where IoU_{NMS}_{ⁱ} is the predefined IoU threshold for NMS, set to 0.30 in [1]. Note that Eq. (A.5) corresponds to the standard NMS if \hat{p}ᵢ is set to 0 for the case that IoU(\hat{b}ᵢ,\hat{b}_{α})≥IoU_{NMS} in which

$${\hat{b}}_{i}^{′}$$

overlaps with \hat{b}_{α} more than a threshold. Differently, Soft NMS decreases the score \hat{p}ᵢ by considering the overlap of

$${\hat{b}}_{i}^{′} with {\hat{b}}_{α} .$$

In the case of a higher overlap, the score \hat{p}ᵢ is reduced more with the intuition that

$${\hat{b}}_{i}^{′}$$

is more likely to detect the same object with \hat{b}_{α}. With the same intuition, the second Soft NMS variant, for Gaussian Soft NMS modifies the scores as follows,

$${\hat{p}}_{i} = {\hat{p}}_{i} {e}^{- \frac{{IoU ( {\hat{b}}_{i} , {\hat{b}}_{α} )}^{2}}{{α}_{NMS}}} , \qquad ( A \text{.6} )$$

where σ_{NMS} is a hyper-parameter to control how much to suppress the scores such that a smaller σ_{NMS} implies that \hat{p}ᵢ is suppressed more. Experiments are presented on how σ_{NMS} affects the performance and it is found that σ_{NMS}∈[0.40, 0.60] typically performs well for MOCAE. Therefore, as Soft NMS is less rigid in removing overlapping detections, it naturally leads to improved recall.

Score Voting[27] aims to refine the final detections after NMS (or Soft NMS). Inspired by [23], the bounding box of a final detection is refined by utilizing the raw detections and their confidence. Specifically, the refined box

$${\hat{b}}_{i}^{′}$$

is obtained as the weighted average of raw bounding boxes \hat{b}ⱼ (i.e., before NMS) as follows,

$${\hat{b}}_{i} = \frac{{\sum }_{j} {\hat{p}}_{j} {\hat{IoU}}_{j} {\hat{b}}_{j}}{\sum {\hat{p}}_{j} {\hat{IoU}}_{j}} , \qquad ( A \text{.7} )$$

where IôUⱼ is

$${\hat{IoU}}_{j} = {e}^{- \frac{{IoU ( {\hat{b}}_{i} , {\hat{b}}_{j} )}^{2}}{{σ}_{SV}}} , \qquad ( A \text{.8} )$$

such that σ_{SV} is the hyper-parameter of Score Voting, which we set to 0.04 in all of our experiments. Note that while Soft NMS keeps the box as it is and updates the confidence score, Score Voting does the opposite by keeping the score as it is and refines the box. As a result, these two approaches adopted in Refining NMS complement each other well, enabling us to obtain a strong aggregator for MOCAE.

### Further Experiments and Analyses

### Further Details on Used Models

Details of the used models are provided as follows. No models have been trained; off-the-shelf detectors have been used with the exception of DEs.

Object detection: Two different configurations are used. In the first one, three detectors are employed with ResNet-50 [21] with FPN [41] backbone. These detectors are:
Rank & Sort R-CNN (RS R-CNN) [52] is a recent representative of the two-stage R-CNN family [56, 12, 67] optimizing a ranking-based loss function,
Adaptive Training Sample Selection (ATSS) [69] is a common one stage baseline,
Probabilistic Anchor Assignment (PAA) [27] relies on the one-stage ATSS architecture but with a different anchor assignment mechanism and postprocessing of the confidence scores.

RS R-CNN and ATSS are obtained from [572 54] and PAA from [8]. All these detectors are trained for 36 epochs using multi-scale training data augmentation in which the shorter side of the image is resized within the range of [480, 800] for RS R-CNN and ATSS and [640, 800] for PAA. Soft NMS and Score Voting for the single detectors. In our second setting, we use the following detectors:
YOLOv7 [60] with a large convolutional backbone following its original setting,
QueryInst [17] as a transformer-based detector with a Swin-L [45] backbone,
ATSS with transformer-based dynamic head [13] and again Swin-L backbone.
   Again, YOLOv7 and dynamic head are obtained from mmdetection [8] and use the official repository of QueryInst [17].

Instance Segmentation Three different Mask R-CNN variants are used for instance segmentation:
The vanilla Mask R-CNN [22] with ResNeXt-101 [64] backbone, softmax classifier and using Repeat Factor Sampling (RFS) to address the long-tailed nature of LVIS,
Mask R-CNN with ResNet-50, sigmoid classifier, trained with RS Loss [52] and RFS,
Mask R-CNN with ResNet-50, softmax classifier, trained with Seesaw Loss[62] but no RFS.

Vanilla Mask R-CNN and Seesaw Loss are obtained from mmdetection. As for Mask R-CNN trained with RS Loss, the official repository of RS Loss [52] is used in which it is trained for 12 epochs using multi-scale training augmentation. The other Mask R-CNN variants also employ multi-scale training augmentation and the Vanilla Mask R-CNN is trained for 12 epochs as well. Differently, Mask R-CNN with Seesaw Loss is trained for 24 epochs and uses the mask normalization technique proposed in the same paper[62].

Rotated Object Detection: Finally for rotated object detection, RTMDet and LSKN as two different detectors are used. RTMDet again is obtained from mmdetection (which is also the official repository for RTMDet) and LSKN from its official repository [40].

### Further Analyses on Calibration

Definitions of the Calibration Errors The calibration criterion in Eq. (4) is introduced. This criterion requires the confidence of a detection to align with its IOU with the ground truth box that the detection overlaps the most. As aforementioned, computing the calibration error based on this criterion corresponds to using an IoU threshold of 0 to validate TPs. This is equivalent to using precision^{c}(j)=1 for class c in Eq. (3), which then reduces to

$${LaECE}^{c} = {\sum }_{j = 1}^{J} \frac{\vert {\hat{𝒟}}_{j}^{c} \vert}{\vert {\hat{𝒟}}^{c} \vert} \vert {\overline{p}}_{j}^{c} - I \overline{o} {U}^{c} ( j ) \vert . \qquad ( A \text{.9} )$$

where [symbol] denotes the set of detections for class c; [symbol] is the set of detections in the jth bin for class c;

$${\overline{p}}_{j}^{c}$$

is the average confidence of the detections in [symbol] and IōU^{c}(j) is the average IOU of the detections in [symbol] Following [54], J=25 is used and average over LaECE^{c} of classes for the detector LaECE.

In addition to LaECE, Localisation-aware Average Calibration Error (LAACE) is defined, and Localisation-aware Maximum Calibration Error (LAMCE) similar to the way how Expected Calibration Error (ECE) is extended to Average Calibration and Maximum Calibration Errors. LAACE and LAMCE are found to be useful as they reduce the dominance of certain bins on the calibration error as in the case of LaECE. This is especially important for early calibration from which thousands of confidence scores are obtained from a single image, most of which have a confidence close to 0. Specifically, in this case, the following is defined: LaACE^{c} for class c as

$${LaACE}^{c} = {\sum }_{j = 1}^{J} \frac{1}{J} \vert {\overline{p}}_{j}^{c} - I \overline{o} {U}^{c} ( j ) \vert , \qquad ( A \text{.10} )$$

and LaMCEc for class c as

$${LaMCE}^{c} = {max}_{j ∈ \{ 1 , 2 … , J \}} \vert {\overline{p}}_{j}^{c} - I \overline{o} {U}^{c} ( j ) \vert . \qquad ( A \text{.11} )$$

Following LAECE, LAACE and LAMCE are obtained for the detector by averaging over the classes. The full version of accuracy and calibration performance comparison of different methods are included in Tab. A.9. This table further confirms the choice of CA IR as it improves LAACE and LAMCE in most of the cases.

500 Images are Sufficient for MOCAE: It is investigated how many images are sufficient for calibration to enable MoEs using MOCAE. Following the literature [19, 54], a calibrator is learnt on a held-out validation set and then report the results on the test set. Our aim here is to determine the cardinality of the held-out validation set to properly calibrate the models. This can help the practitioners to avoid reserving redundant data for this held-out validation set. For this analysis, calibrators are learnt on both early and late calibration setting by using different number of images.

FIG. 5 presents how LOECE, LOACE and LOMCE change when the cardinality of the hold-out validation set changes on three different detectors in sub figures FIG. 5(a-c) respectively. The effect of number of images on calibration using CA IR is shown. It is found that it is sufficient to use only 500 images for calibration. It is observed in general that calibration errors drop significantly even when only 50 images are used to learn the calibrators. This is shown in FIG. 5(a) for LaECE, where the calibration error drops significantly going from 0 images (errors in circle 802) to 50 images (errors in circle 804). This is shown in FIG. 5(b) for LaACE, where the calibration error drops significantly going from 0 images (errors in circle 806) to 50 images (errors in circle 808). This is shown in FIG. 5(c) for LaMCE, where the calibration error generally drops significantly going from 0 images (errors in circle 810) to 50 images (errors in circle 812). With more images, while a notable gain is not observed in LAECE (FIG. 5(a)), LAACE (FIG. 5(b)) and LAMCE (FIG. 5(c)) continue to improve especially for early calibration, implying the necessity for these calibration errors. Overall, a notable gain is not observed after 500 images, hence 500 images are kept on the held-out validation set while training the calibrators.

Further Comparison of Early and Late Calibration: Here, further comparisons on early and late calibration are provided. In Tab. A.10, it can be seen that while both approaches improve single models, late calibration performs slightly better than early calibration consistently.

TABLE A.10
Further experiments comparing early and late calibration.
Standard NMS is used for both of the methods. While both
approaches improve single models, late calibration performs
slightly better.

| Cali- | | | | | | | | | |
|---|---|---|---|---|---|---|---|---|---|
| bra- | RS | | | | | | | | |
| tion | R- | | | | | | | | |
| Type | CNN | ATSS | PAA | AP | AP₅₀ | AP₇₅ | AP_{S} | AP_{M} | AP_{L} |
| N/A | ✓ | | | 42.4 | 62.1 | 46.2 | 26.8 | 46.3 | 56.9 |
| (Single | | ✓ | | 43.1 | 61.5 | 47.1 | 27.8 | 47.5 | 54.2 |
| Models) | | | ✓ | 43.2 | 60.8 | 47.1 | 27.0 | 47.0 | 57.6 |
| Early | ✓ | ✓ | | 43.9 | 63.5 | 47.9 | 28.6 | 47.9 | 56.9 |
| Late | ✓ | ✓ | | 44.1 | 63.0 | 48.4 | 28.5 | 48.4 | 56.8 |
| Early | ✓ | | ✓ | 43.8 | 63.3 | 47.7 | 28.1 | 47.8 | 57.6 |
| Late | ✓ | | ✓ | 44.0 | 62.7 | 47.9 | 28.2 | 48.2 | 58.1 |
| Early | | ✓ | ✓ | 44.3 | 63.1 | 47.8 | 28.8 | 48.1 | 56.7 |
| Late | | ✓ | ✓ | 44.4 | 62.5 | 48.5 | 29.2 | 48.5 | 57.3 |
| Early | ✓ | ✓ | ✓ | 44.5 | 63.7 | 48.4 | 29.0 | 48.5 | 57.5 |
| Late | ✓ | ✓ | ✓ | 44.7 | 63.1 | 48.9 | 29.2 | 49.0 | 58.2 |

Furthermore, practically speaking, late calibration is significantly simpler. This is because the number of confidence scores obtained before post-processing is significantly larger than that obtained after post-processing (i.e., final detections). To illustrate on RS R-CNN, which outputs 1K proposals for each image as raw detections, a single image results in 80K raw confidence scores for COCO dataset and more than 1 M scores for LVIS as each proposal has a score for each class. Also considering that, a very large amount of these raw detections do not overlap with any object, the problem gets more challenging as well due to the imbalanced nature of the data. While we use RS R-CNN, a two-stage detector, as an example, the number of raw confidence scores is significantly larger for one-stage detectors which makes predictions directly from a very large number of anchors; making early calibration even more impractical for such detectors. To keep this number manageable, we top-1000 detections predicted from each pyramid level for ATSS and PAA for early calibration are used. On the other hand, we use only top-100 detections in COCO and top-300 detections in LVIS for each image following the evaluation specification of these datasets. Thereby resulting in more practical scenarios with significantly smaller number of detections for late calibration compared to early. Consequently, considering its slight accuracy gain as well as simplicity, we prefer late calibration over early to obtain MoEs in MOCAE.

Effect of Different Calibration Methods on MoEs CA IR is chosen as calibration method in MOCAE, here we present how different calibration methods perform in obtaining MoEs. Specifically, late calibration is used with CA LR and CW LR as these two methods also preserve the accuracy of single models as shown in Tab. 7. Tab. A.11 presents the results where we can see that CA calibrators perform better than CW LR.

TABLE A.11
Comparison of different calibration methods to obtain
MoEs. CA IR performs better than other methods.

| | RS | | | | | | | | |
|---|---|---|---|---|---|---|---|---|---|
| Cali- | R- | | | | | | | | |
| brated | CNN | ATSS | PAA | AP | AP50 | AP75 | APS | APM | APL |
| N/A | ✓ | | | 42.4 | 62.1 | 46.2 | 26.8 | 46.3 | 56.9 |
| (Single | | ✓ | | 43.1 | 61.5 | 47.1 | 27.8 | 47.5 | 54.2 |
| Mod- | | | ✓ | 43.2 | 60.8 | 47.1 | 27.0 | 47.0 | 57.6 |
| els) | | | | | | | | | |
| x | ✓ | ✓ | | 42.4 | 62.1 | 46.3 | 26.8 | 46.3 | 56.9 |
| CW | ✓ | ✓ | | 43.0 | 61.4 | 46.9 | 28.1 | 47.2 | 54.4 |
| LR | | | | | | | | | |
| CA | ✓ | ✓ | | 43.7 | 62.5 | 47.7 | 28.7 | 48.2 | 55.2 |
| LR | | | | | | | | | |
| CA | ✓ | ✓ | | 44.1 | 63.0 | 48.4 | 28.5 | 48.4 | 56.8 |
| IR | | | | | | | | | |
| x | ✓ | | ✓ | 43.4 | 62.5 | 47.1 | 27.3 | 47.3 | 58.0 |
| CW | ✓ | | ✓ | 42.7 | 61.8 | 46.7 | 27.1 | 46.5 | 57.6 |
| LR | | | | | | | | | |
| CA | ✓ | | ✓ | 43.5 | 63.0 | 47.7 | 27.9 | 47.5 | 57.8 |
| LR | | | | | | | | | |
| CA | ✓ | | ✓ | 44.0 | 62.7 | 47.9 | 28.2 | 48.2 | 58.1 |
| IR | | | | | | | | | |
| x | | ✓ | ✓ | 43.3 | 60.9 | 47.2 | 27.1 | 47.2 | 57.6 |
| CW | | ✓ | ✓ | 42.6 | 60.7 | 46.5 | 26.6 | 47.2 | 53.9 |
| LR | | | | | | | | | |
| CA | | ✓ | ✓ | 44.4 | 62.5 | 48.3 | 29.0 | 48.3 | 57.3 |
| LR | | | | | | | | | |
| CA | | ✓ | ✓ | 44.4 | 62.5 | 48.5 | 29.2 | 48.5 | 57.3 |
| IR | | | | | | | | | |
| x | ✓ | ✓ | ✓ | 43.4 | 62.5 | 47.1 | 27.3 | 47.3 | 58.0 |
| CW | ✓ | ✓ | ✓ | 43.0 | 61.3 | 47.1 | 28.2 | 47.4 | 54.6 |
| LR | | | | | | | | | |
| CA | ✓ | ✓ | ✓ | 44.0 | 62.7 | 48.1 | 29.0 | 48.5 | 55.8 |
| LR | | | | | | | | | |
| CA | ✓ | ✓ | ✓ | 44.7 | 63.1 | 48.9 | 29.2 | 49.0 | 58.2 |
| IR | | | | | | | | | |

Secondly, while CA LR obtains on par performance with CA IR while combining ATSS and PAA, it performs worse once RS R-CNN is in the mixture. This is because the calibration error of CA LR is higher than CA IR (for late calibration) in terms of all calibration measures as shown in Tab. 7). This suggests that CA LR cannot mitigate the incompatibility of the detectors properly with a higher calibration error. Considering these results and calibration performance, CA IR is preferred while obtaining MoEs via our MOCAE.

### Further Details and Analyses on Deep Ensembles

Obtaining DEs and the Effect of Calibration on Des: DEs combine the same models that are trained from different initializations of the parameters. Ideally, the expectation over the predictive distributions of the components in a DE yields the prediction of the DE. This can be easily obtained for classifiers which predict a categorical distribution over the classes given an input image. On the other hand, it is not straightforward to use DEs for detectors as there is no clear way to associate detections from different detectors. As a result, similar to MOCAE, we obtain DEs by using late calibration as shown in FIG. 3(a), which turns out to be an effective method. To see that, the single model performance of the five different components comprising DEs is presented in Tab. A.12.

TABLE A.12
Single model performance of the detectors that we used in
DEs. While obtaining MOEs, “Model 1” of different
types of detectors are combined.

| Model | AP | AP₅₀ | AP₇₅ | AP_{S} | AP_{M} | AP_{L} |
|---|---|---|---|---|---|---|
| RS R-CNN (Model 1) | 42.4 | 62.1 | 46.2 | 26.8 | 46.3 | 56.9 |
| RS R-CNN (Model 2) | 42.6 | 62.7 | 46.7 | 27.3 | 46.5 | 55.8 |
| RS R-CNN (Model 3) | 42.6 | 62.6 | 46.5 | 27.2 | 46.8 | 56.1 |
| RS R-CNN (Model 4) | 42.6 | 62.3 | 46.1 | 27.9 | 46.1 | 55.9 |
| RS R-CNN (Model 5) | 42.2 | 62.8 | 45.8 | 26.7 | 46.5 | 55.7 |
| ATSS (Model 1) | 43.1 | 61.5 | 47.1 | 27.8 | 47.5 | 54.2 |
| ATSS (Model 2) | 43.3 | 61.5 | 47.5 | 28.9 | 47.8 | 55.0 |
| ATSS (Model 3) | 43.3 | 61.5 | 47.0 | 28.9 | 47.9 | 55.8 |
| ATSS (Model 4) | 43.0 | 61.2 | 46.8 | 29.0 | 47.4 | 54.6 |
| ATSS (Model 5) | 43.3 | 61.5 | 47.5 | 28.2 | 47.7 | 54.8 |
| PAA (Model 1) | 43.2 | 60.8 | 47.1 | 27.0 | 47.0 | 57.6 |
| PAA (Model 2) | 43.5 | 61.0 | 47.3 | 27.5 | 47.7 | 57.7 |
| PAA (Model 3) | 43.4 | 61.1 | 47.2 | 27.7 | 47.6 | 57.8 |
| PAA (Model 4) | 43.6 | 61.4 | 47.2 | 27.6 | 47.6 | 57.6 |
| PAA (Model 5) | 43.6 | 61.3 | 47.2 | 27.9 | 47.9 | 58.0 |

Then, from these single detectors, we obtain DEs for PAA with and without calibration using the standard NMS. Tab. A.13 shows that this way of obtaining DEs is effective as the performance increases when the number of components increases.

TABLE A.13
The effect of increasing the components and using
calibration on DEs. Increasing the components im-
proves the performance while calibration does not
have a notable effect on performance for DEs
unlike their importance for MoEs.

| Model | Calibration | AP | AP₅₀ | AP₇₅ | AP_{S} | AP_{M} | AP_{L} |
|---|---|---|---|---|---|---|---|
| PAA × 2 | x | 43.8 | 61.4 | 47.6 | 28.2 | 48.3 | 58.3 |
| | ✓ | 43.9 | 61.4 | 47.7 | 28.0 | 48.3 | 58.6 |
| PAA x 3 | x | 44.1 | 61.5 | 48.0 | 28.8 | 48.7 | 58.8 |
| | ✓ | 44.1 | 61.6 | 48.0 | 28.7 | 48.7 | 58.9 |
| PAA × 4 | x | 44.3 | 61.7 | 48.3 | 28.9 | 48.8 | 59.1 |
| | ✓ | 44.3 | 61.7 | 48.3 | 28.9 | 48.8 | 59.1 |
| PAA × 5 | x | 44.4 | 61.7 | 48.6 | 29.1 | 49.0 | 59.3 |
| | ✓ | 44.4 | 61.7 | 48.6 | 28.9 | 49.0 | 59.3 |

It is observed that increasing the number of components improve the performance between 669 0.1-0.3 AP. On the other hand, as there is no incompatibility among different detectors in a DE, the effect of calibration is not notable for DEs.

Comparison with DEs with Less Components: For the sake of completeness, Tab. A.14 extends the comparison in Tab. 3 by including the DEs with 3 components.

TABLE A.14
Comparison of our M_{O}C_{A}E with DEs and Vanilla MoE. MoEs
obtained by our MoCAE outperforms DEs significantly even
with less detectors. Our gains are obtained compared to the
best single model for each performance measure, represented
as underlined. The gap between DEs and our MoCAE in-
creases when the number of components is 3 for DEs.

| Model | | | | | | | |
|---|---|---|---|---|---|---|---|
| Type | Detector | AP | AP₅₀ | AP₇₅ | AP_{S} | AP_{M} | AP_{L} |
| Single | RS R-CNN | 42.4 | 62.1 | 46.2 | 26.8 | 46.3 | 56.9 |
| Models | ATSS | 43.1 | 61.5 | 47.1 | 27.8 | 47.5 | 54.2 |
| | PAA | 43.2 | 60.8 | 47.1 | 27.0 | 47.0 | 57.6 |
| Deep | RS R-CNN × 3 | 44.9 | 63.0 | 48.5 | 28.2 | 48.4 | 58.5 |
| En- | RS R-CNN × 5 | 44.5 | 63.0 | 49.1 | 28.8 | 48.6 | 58.4 |
| sembles | ATSS × 3 | 43.9 | 62.4 | 47.5 | 29.2 | 48.4 | 55.9 |
| | ATSS × 5 | 44.1 | 62.4 | 48.0 | 29.7 | 48.6 | 56.2 |
| | PAA × 3 | 44.2 | 62.0 | 47.9 | 28.2 | 48.3 | 59.1 |
| | PAA × 5 | 44.5 | 62.3 | 48.3 | 28.6 | 48.7 | 59.3 |
| Mix- | Vanilla MoE | 44.4 | 62.6 | 48.2 | 27.8 | 48.4 | 59.3 |
| tures | with Ref. NMS | | | | | | |
| of | (RS R-CNN, | | | | | | |
| Ex- | ATSS, PAA) | | | | | | |
| perts | M_{O}C_{A}E | 44.8 | 62.4 | 49.2 | 29.4 | 49.1 | 57.6 |
| | (ATSS and | | | | | | |
| | PAA) - Ours | | | | | | |
| | M_{O}C_{A}E | 45.5 | 63.2 | 50.0 | 29.7 | 49.7 | 59.3 |
| | (RS R-CNN, | +2.3 | +2.1 | +2.9 | +1.9 | +2.2 | +1.6 |
| | ATSS, PAA) - | | | | | | |
| | Ours | | | | | | |

Considering that the best MoE obtained via MOCAE also includes 3 components, these experiments compare DEs and MOCAE with the same number of components. To compare them in their best setting, Refining NMS is used in all of the models. Tab. A.14 presents that with equal number of components, the MOCAE outperfonms the best DE with 3 components by 1.3 AP; further demonstrating its effectiveness.

### Sensitivity of MOCAE to Design Choices in Refining NMS

As introduced above, Refining NMS combines Soft NMS and Score Voting. Specifically, Soft NMS can be linear or gaussian; furthermore both Soft NMS (either linear or gaussian) and Score Voting have hyper-parameters. The sensitivity of MOCAE to such design choices is investigated using Soft NMS as an example using RS R-CNN, ATSS and PAA for COCO; and the setting described above for LVIS.

TABLE A.15
Sensitivity of Vanilla MoE and MoC_{A}E to different configurations
of Soft NMS. The results are presented on COCO mini-test and 500
validation images that we used to train the calibrators for LVIS.

| Method | Soft NMS | COCO (box AP) | LVIS (mask AP) |
|---|---|---|---|
| Vanilla | x | 43.4 | 37.5 |
| MoE | Linear, IoU_{NMS} = 0.65 | 43.4 | 37.5 |
| | Gaussian, σ_{NMS} = 0.20 | 41.6 | 37.9 |
| | Gaussian, σ_{NMS} = 0.40 | 42.1 | 37.8 |
| | Gaussian, σ_{NMS} = 0.60 | 42.4 | 37.9 |
| | Gaussian, σ_{NMS} = 0.80 | 42.7 | 37.8 |
| | Gaussian, σ_{NMS} = 1.00 | 42.9 | 37.9 |
| MoC_{A}E | x | 44.7 | 39.8 |
| | Linear, IoU_{NMS} = 0.65 | 44.8 | 39.9 |
| | Gaussian, σ_{NMS} = 0.20 | 43.7 | 40.6 |
| | Gaussian, σ_{NMS} = 0.40 | 44.4 | 40.8 |
| | Gaussian, σ_{NMS} = 0.60 | 44.8 | 40.6 |
| | Gaussian, σ_{NMS} = 0.80 | 44.7 | 40.2 |
| | Gaussian, σ_{NMS} = 1.00 | 44.6 | 39.9 |

It can be seen in Tab. A.15 that Vanilla MoE does not benefit properly from Soft NMS without calibration. For example, there is no gain for Linear Soft NMS, the performance degrades for the Gaussian Soft NMS on COCO and the gain is only 0.4 for LVIS. This is expected as a single hyper-parameter to reconciliate the scores all detectors might not be sufficient especially for the Gaussian Soft NMS. On the other hand, after calibration, we consistently see the gains for the MOCAE: MOCAE benefits slightly on COCO dataset both for linear and gaussian cases; and besides, the gain on LVIS is 1.0 mask AP. This is because, the scores are compatible for each detector after calibration and a single hyperparameter allows Soft NMS to properly adjust the scores from different detectors. Linear Soft NMS is chosen on COCO resulting in the best results for Vanilla MoE and MOCAE. For LVIS, Gaussian Soft NMS is used with σ_{NMS}=0.40 for MOCAE. In a similar way, the hyper-parameter of Score Voting as 0.04 is validated.

### The Contribution of MOCAE on Performance Aspects

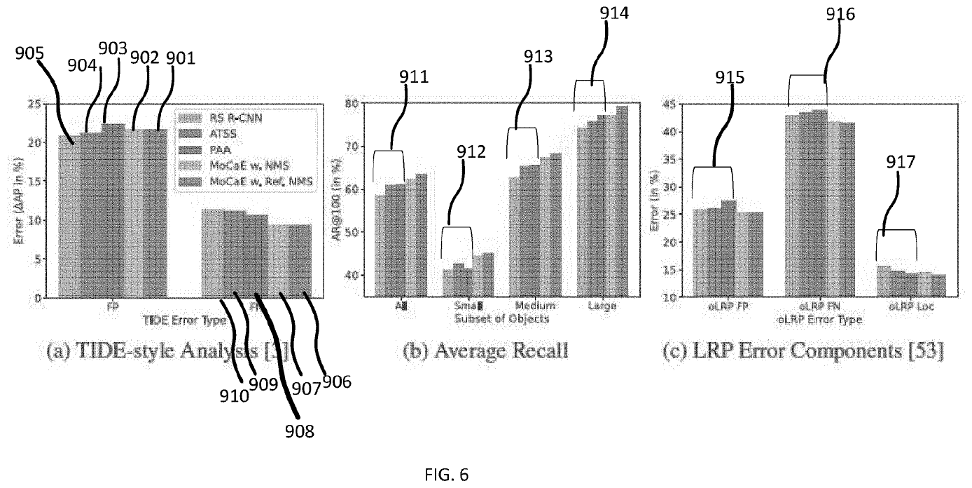

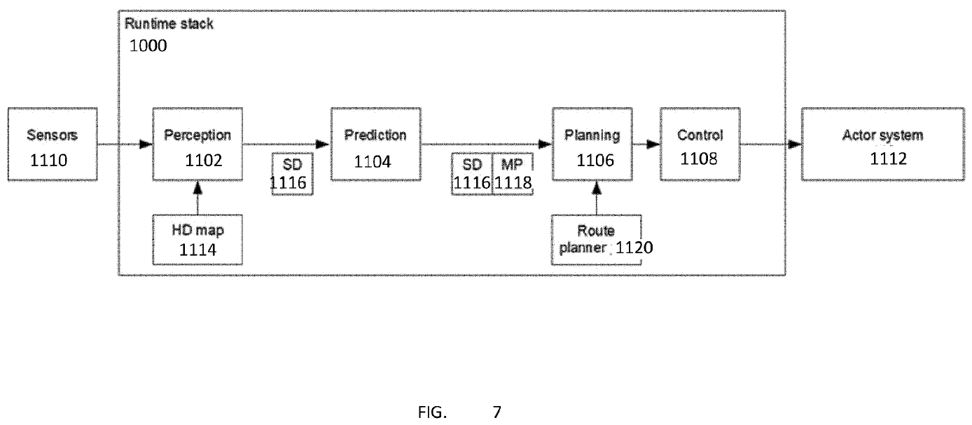

An analysis is made of what performance aspects, among localisation, recall and precision, are affected by MOCAE by exploiting three different analyses tools from the detection literature. First, TIDE is used that defines oracle APs as the APs obtained when FP and false-negative (FN) errors are completely mitigated. Then, the difference between the oracle and actual AP correspond to the error of a detector for a specific performance aspect. More specifically, while obtaining Oracle FP AP, the FP detections are simply removed from the final detection set. As for Oracle FN AP, the FN objects are removed from the dataset. FIG. 6(a) shows the contribution of MOCAE on performance aspects. MOCAE variants (901, 902) perform similar to the single detectors (903-905) in terms of FP Error (20-23%) while they (906-907) clearly outperform them (908-910) on FN Error. This indicates that one of the contributions of MoE is to find the objects that are not detected by at least one of the individual detector as illustrated on FIG. 1 and Tab. 1. However, TIDE analysis does not provide insight on the localisation quality which is mainly targeted by Refining NMS. FIG. 6(b) shows the second analysis where AR is defined as the average of the recall values over 10 IoUs from 0.50 to 0.95 is used. Aligned with the observation in TIDE analysis, FIG. 6(b) presents that MOCAE improves AR of the single detectors. The recalls of the single detectors are shown by the brackets 911 for all types of objects, 912 for small objects, 913 for medium objects, and 914 for large objects. From FIG. 6(b), it can be seen that the average recall of the single detectors is around 60%, 40%, 65%, 75% for all objects, small objects, medium objects and large objects respectively. From FIG. 6(b), it can be seen that the corresponding recall values for MoE detectors (not in brackets) is around 63%, 67%, 69%, and 79% for all objects, small objects, medium objects and large objects respectively. Furthermore, the performance gain mainly originates from the improvement in small and medium objects as MOCAE does not improve the performance on large objects notably. This indicates that the resulting MoE is especially stronger than single detectors in more challenging object categories. Using Refining NMS further boosts the AR performance as it improves the localisation performance, which is critical for recalls with higher IoUs. FIG. 6(c) shows the results of investigating the benefit of MoE in practical use-cases, through an LRP analysis [53, 50]. In FIG. 6(c), oLRP FP, FN and Loc correspond to the components Optimal LRP Error defined as 1-Precision, 1-Recall and the average IoU Error of TP detections. The errors shown in brackets 915, 916, and 917 correspond to single detector errors for oLRP FP, FN and Loc respectively, which are around 25%, 42% and 15% respectively. The corresponding MoE errors (not in brackets) are around 24%, 40%, and 12% respectively. Aligned with our previous analysis, MoE mainly decreases the recall error and MOCAE with Refining NMS mainly contributes to the oLRP Loc component, outperforming all individual models in the end. These three different analyses confirm that MOCAE with NMS mainly decreases the recall error of the detector and using Refining NMS contributes to the localisation error.

Tab. A.16 presents the details of the evaluation on LVIS; Tab. A.17 includes the performance of all classes for DOTA dataset; and Tab. A.18 shows the exact values used to obtain FIG. 4.

TABLE A.16
shows detailed results on LVIS val set. The detectors have different characteristics
in terms of exploiting Repeat Factor Sampling (RFS), backbone, the number of
training epochs and the loss function. While Vanilla MoE does not yield gain,
M_{O}C_{A}E enables a stronger MoE than all single detectors.

| | | Back- | | Instance Segmentation Performance | | | | | | Object Detection Performance | | | | | |
|---|---|---|---|---|---|---|---|---|---|---|---|---|---|---|---|
| Method | RFS | bone | Epoch | AP | AP₅₀ | AP₇₅ | APᵣ | AP_{c} | AP_{f} | AP | AP₅₀ | AP₇₅ | APᵣ | AP_{c} | AP_{f} |
| Seesaw | x | ResNet- | 24 | 25.4 | 39.5 | 26.9 | 15.8 | 24.7 | 30.4 | 25.6 | 41.6 | 26.6 | 14.0 | 24.0 | 32.3 |
| Mask | | 50 | | | | | | | | | | | | | |
| R-CNN | | | | | | | | | | | | | | | |
| [62] | | | | | | | | | | | | | | | |
| RS Mask R- | ✓ | ResNet- | 12 | 25.1 | 38.2 | 26.8 | 16.5 | 24.3 | 29.9 | 25.8 | 39.7 | 27.8 | 15.1 | 24.5 | 32.0 |
| CNN [52] | | 50 | | | | | | | | | | | | | |
| Mask R- | ✓ | ResNext- | 12 | 25.4 | 39.2 | 27.3 | 15.7 | 24.7 | 30.4 | 26.6 | 42.1 | 28.5 | 15.4 | 25.2 | 33.1 |
| CNN [22] | | 101 | | | | | | | | | | | | | |
| Vanilla | N/A | N/A | N/A | 25.2 | 38.3 | 26.8 | 16.5 | 24.3 | 29.9 | 25.9 | 39.8 | 27.9 | 15.1 | 24.5 | 32.2 |
| MoB | | | | −0.2 | −1.2 | −0.5 | 0.0 | −0.4 | −0.5 | −0.7 | −2.3 | −0.6 | −0.3 | −0.7 | −0.9 |
| M_{O}C_{A}E | N/A | N/A | N/A | 27.7 | 42.8 | 29.4 | 18.2 | 27.3 | 32.4 | 29.1 | 44.8 | 31.4 | 17.0 | 27.9 | 36.8 |
| (Ours) | | | | +2.3 | +3.3 | +2.1 | +1.7 | +2.4 | +2.0 | +2.5 | +1.6 | +2.9 | +1.6 | +2.7 | +2.7 |

TABLE A.17
shows the performance of all classes on DOTA v1.0. AP₅₀ reported as the performance measure of DOTA.

| | | Dataset Classes | | | | | | | |
|---|---|---|---|---|---|---|---|---|---|
| Detector | All | Plane | Baseba. | Bridge | Ground-t | Small-veh. | Large-veh. | Ship | Tennis |
| RTMDet | 81.32 | 88.04 | 86.20 | 58.50 | 82.43 | 81.21 | 84.87 | 88.70 | 90.89 |
| LSKN (prev. SOTA) | 81.85 | 89.69 | 85.70 | 61.47 | 83.23 | 81.37 | 86.05 | 88.64 | 90.88 |
| Vanilla M_{O}E | 80.60 | 87.76 | 83.27 | 61.77 | 78.25 | 81.26 | 85.33 | 88.34 | 89.93 |
| | −1.25 | −1.93 | −2.93 | +0.30 | −4.98 | −0.11 | −0.72 | −0.36 | −0.11 |
| M_{O}C_{A}E | 82.62 | 89.09 | 86.47 | 61.38 | 83.28 | 81.43 | 85.03 | 88.72 | 90.86 |
| (Ours) | +0.77 | −0.60 | +0.27 | −0.09 | +0.05 | +0.06 | −1.02 | +0.02 | −0.03\| |

| | Dataset Classes | | | | | | |
|---|---|---|---|---|---|---|---|
| Detector | Basket. | Storag. | Soccer | Roundab. | Harbor | Swimm. | Helico. |
| RTMDet | 88.75 | 87.33 | 72.12 | 70.85 | 81.16 | 81.49 | 77.24 |
| LSKN (prev. SOTA) | 88.49 | 87.40 | 71.67 | 71.35 | 79.19 | 81.77 | 80.85 |
| Vanilla M_{O}E | 85.54 | 86.35 | 70.98 | 65.92 | 84.28 | 82.45 | 77.57 |
| | −0.96 | −1.05 | −1.14 | −5.43 | +3.12 | +0.68 | −3.28 |
| M_{O}C_{A}E | 88.31 | 87.11 | 75.50 | 74.12 | 84.49 | 81.63 | 81.93 |
| (Ours) | −0.44 | −0.29 | +3.38 | +2.77 | +3.33 | −0.14 | +1.08 |

TABLE A.18
The values used in FIG. 4. The area of the dots are associated
with the NMS time for the detectors given a specific background
removal threshold. Early calibration regularizes the behaviour
of the detectors by reducing their sensitivity to background
removal threshold with respect to AP and NMS time. NMS time is
measured in terms of ms using a single Nvidia 1080ti GPU.

| Background Removal | | Uncalibrated | | Early Calibrated | |
|---|---|---|---|---|---|
| Threshold | Detector | AP | NMS time | AP | NMS time |
| 0.05 | F-RCNN | 40.1 | 0.5 | 40.3 | 0.6 |
| | RS-RCNN | 42.4 | 35.4 | 42.4 | 0.6 |
| | ATSS | 43.1 | 0.6 | 43.1 | 0.7 |
| | PAA | 43.3 | 29.2 | 43.2 | 0.8 |
| 0.25 | F-RCNN | 38.6 | 0.4 | 39.6 | 0.5 |
| | RS-RCNN | 42.4 | 2.0 | 41.9 | 0.5 |
| | ATSS | 38.0 | 0.5 | 42.7 | 0.6 |
| | PAA | 43.2 | 1.1 | 42.7 | 0.5 |
| 0.50 | F-RCNN | 36.2 | 0.4 | 35.7 | 0.4 |
| | RS-RCNN | 42.1 | 0.4 | 38.6 | 0.4 |
| | ATSS | 19.3 | 0.4 | 39.3 | 0.5 |
| | PAA | 39.2 | 0.5 | 39.3 | 0.5 |
| 0.75 | F-RCNN | 32.1 | 0.4 | 26.5 | 0.4 |
| | RS-RCNN | 25.1 | 0.4 | 30.4 | 0.4 |
| | ATSS | 1.4 | 0.0 | 30.7 | 0.5 |
| | PAA | 21.0 | 0.4 | 29.6 | 0.5 |

### Conclusion

It has been shown that the incompatibility of the confidences across the detectors is the major challenge to obtain MoEs in object detection. To address this, MOCAE was introduced as a simple, principled and effective approach. MOCAE combines post-hoc calibration methods such as IR with an aggregation step which can be implemented by NMS. Specifically via calibration, the confidence was aligned with the IoU of the detection with the object that it overlaps the most. It was shown that this is a useful calibration target, resulting in accurate MoEs with consistent gains across different detection tasks.

### EXAMPLE APPLICATION

Machine learning object detection has numerous applications across many technical fields. Purely by way of example, a robotics application of the described object detections methods is described, focusing on mobile robots such as autonomous vehicles.

FIG. 7 shows, by way of context, a highly schematic block diagram of an AV runtime stack 1100. The stack 100 may be fully or semi-autonomous. For example, the stack 1100 may operate as an Autonomous Driving System (ADS) or Advanced Driver Assist System (ADAS).

The run time stack 1100 is shown to comprise a perception system 1102, a prediction system 1104, a planning system (planner) 1106 and a control system (controller) 1108.

In a real-world context, the perception system 1102 receives sensor outputs from an on-board sensor system 1110 of the AV, and uses those sensor outputs to detect external agents and measure their physical state, such as their position, velocity, acceleration etc. The on-board sensor system 1110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 1110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 1102 comprises a MoE object detector, which in turn comprises multiple calibrated object detectors and a merging component that merges the outputs of the calibrated object detectors using the calibrated confidence scores in the manner described above.

The merged perception outputs from the perception system 1102 are used by the prediction system 1104 to predict future behaviour of external actors (agents), such as other vehicles, pedestrians and other vulnerable road users (VRUs) in the vicinity of the AV.

As is increasingly common in the AV space, the stack 1100 may be subject to simulation-based testing to verify safety and performance. In a simulation context, depending on the nature of the testing, it may or may not be necessary to model the on-board sensor system 1100. For example, when only the planner 1106 (or only the planner 1106 and controller 1108) are tested on a ‘perfect’ representation of the scenario (that is, directly on simulator ground truth), simulated sensor data is not required therefore complex sensor modelling is not required. Surrogate model(s) of the perception system 1102 (or part(s) of it) can also be used to test planner performance (or planner and controller performance) in the presence of realistic perception errors, without the use of sensor models.

In a simulation-based testing context, the perception system 1104 may operate on simulated data of various forms.

Predictions computed by the prediction system 1104 are provided to the planner 1106, which uses the predictions to make autonomous driving decisions to be executed by the AV in a given driving scenario. The inputs received by the planner 1106 would typically indicate a drivable area and would also capture predicted movements of any external agents (obstacles, from the AV's perspective) within the drivable area. The driveable area can be determined using perception outputs from the perception system 1102 in combination with map information, such as an HD (high definition) map.

A core function of the planner 1106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 1120, also referred to as a goal generator 1120.

The controller 1108 executes the decisions taken by the planner 1106 by providing suitable control signals to an on-board actor system 1112 of the AV. In particular, the planner 1106 plans trajectories for the AV and the controller 1108 generates control signals to implement the planned trajectories. Typically, the planner 1106 will plan into the future, such that a planned trajectory may only be partially implemented at the control level before a new trajectory is planned by the planner 1106. The actor system 1112 includes “primary” vehicle systems, such as braking, acceleration and steering systems, as well as secondary systems (e.g. signalling, wipers, headlights etc.).

In simulation-based testing, the planner 1106 or controller 1108 controls a simulated ego agent in a simulation environment that includes simulated pedestrian(s)/VRU(s).

Within the stack 1100, a scenario description 1116 may be used as a basis for planning and prediction. The scenario description 1116 is generated using the perception system 1102, together with a high-definition (HD) map 1114. By localizing the ego vehicle 1114 on the map, it is possible to combine the information extracted in the perception system 1104 (including dynamic agent information) with the pre-existing environmental information contained in the HD map 1114. The scenario description 1116 is, in turn, used as a basis for motion prediction in the prediction system 1104, and the resulting motion predictions 1118 are used in combination with the scenario description 1116 as a basis for planning in the planning system 1106.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

### REFERENCES

The following are incorporated by reference herein in their entirety:
[1] Bodla N, Singh B, Chellappa R, Davis LS (2017) Soft-nms—improving object detection with one line of code. In: IEEE/CVF International Conference on Computer Vision (ICCV)
[2] Bolya D, Zhou C, Xiao F, Lee Y J (2019) Yolact: Real-time instance segmentation. In: IEEE/CVF International Conference on Computer Vision (ICCV)
[3] Bolya D, Foley S, Hays J, Hoffman J (2020) Tide: A general toolbox for identifying object detection errors. In: The IEEE European Conference on Computer Vision (ECCV)
[4] Caesar H, Bankiti V, Lang A H, Vora S, Liong V E, Xu Q, Krishnan A, Pan Y, Baldan G, Beijbom O (2020) nuscenes: A multimodal dataset for autonomous driving. In: IEEE/CVF Conference on Computer Vision and Pattern Recognition (CVPR)
[5] Cai Z, Vasconcelos N (2018) Cascade R-CNN: Delving into high quality object detection. In: IEEE/CVF Conference on Computer Vision and Pattern Recognition (CVPR)
[6] Carion N, Massa F, Synnaeve G, Usunier N, Kirillov A, Zagoruyko S (2020) End-to-end object detection with transformers. In: European Conference on Computer Vision (ECCV)
[7] Casado-García Á, Heras J (2020) Ensemble methods for object detection. In: European Conference on Artificial Intelligence
[8] Chen K, Wang J, Pang J, Cao Y, Xiong Y, Li X, Sun S, Feng W, Liu Z, Xu J, Zhang Z, Cheng D, Zhu C, Cheng T, Zhao Q, Li B, Lu X, Zhu R, Wu Y, Dai J, Wang J, Shi J, Ouyang W, Loy C C, Lin D (2019) MMDetection: Open mmlab detection toolbox and benchmark. arXiv 1906.07155
[9] Chen K, Lin W, li J, See J, Wang J, Zou J (2020) Ap-loss for accurate one-stage object detection. IEEE Transactions on Pattern Analysis and Machine Intelligence (TPAMI) pp 1-1
[10] Chen Y, Li Y, Kong T, Qi L, Chu R, Li L, Jia J (2021) Scale-aware automatic augmentation for object detection. In: IEEE Conference on Computer Vision and Pattern Recognition (CVPR)
[11] Cheng J, Vasconcelos N (2022) Calibrating deep neural networks by pairwise constraints. In: Proceedings of the IEEE/CVF Conference on Computer Vision and Pattern Recognition (CVPR)
[12] Dai J, Li Y, He K, Sun J (2016) R-FCN: Object detection via region-based fully convolutional networks. In: Advances in Neural Information Processing Systems (NeurIPS)
[13] Dai X, Chen Y, Xiao B, Chen D, LiuM, Yuan L, Zhang L (2021) Dynamic head: Unifying object detection heads with attentions. In: Proceedings of the IEEE/CVF Conference on Computer Vision and Pattern Recognition (CVPR), pp 7373-7382
[14] Duan K, Bai S, Xie L, Qi H, Huang Q, Tian Q (2019) Centernet: Keypoint triplets for object detection. In: IEEE/CVF International Conference on Computer Vision (ICCV)
[15] Dwibedi D, Misra I, Hebert M (2017) Cut, paste and learn: Surprisingly easy synthesis for instance detection. In: IEEE/CVF International Conference on Computer Vision (ICCV)
[16] Fang H, Sun J, Wang R, Gou M, Li Y L, Lu C (2019) Instaboost: Boosting instance segmentation via probability map guided copy-pasting. 2019 IEEE/CVF International Conference on Computer Vision (ICCV) pp 682-691
[17] Fang Y, Yang S, Wang X, Li Y, Fang C, Shan Y, Feng B, Liu W (2021) Instances as queries. In: Proceedings of the IEEE/CVF International Conference on Computer Vision (ICCV), pp 6910-6919
[18] Geiger A, Lenz P, Urtasun R (2012) Are we ready for autonomous driving? the kitti vision benchmark suite. In: Conference on Computer Vision and Pattern Recognition (CVPR)
[19] Guo C, Pleiss G, Sun Y, Weinberger K Q (2017) On calibration of modern neural networks. In: Precup D, Teh Y W (eds) Proceedings of the 34th International Conference on Machine Learning, PMLR, Proceedings of Machine Learning Research, vol 70, pp 1321-1330
[20] Gupta 360 A, Dollar P, Girshick R (2019) Lvis: A dataset for large vocabulary instance segmentation. In: The IEEE Conference on Computer Vision and Pattern Recognition (CVPR)
[21] He K, Zhang X, Ren S, Sun J (2016) Deep residual learning for image recognition. In: IEEE/CVF Conference on Computer Vision and Pattern Recognition (CVPR)
[22] He K, Gkioxari G, Dollar P, Girshick R (2017) Mask R-CNN. In: IEEE/CVF International Conference on Computer Vision (ICCV)
[23] He Y, Zhu C, Wang J, Savvides M, Zhang X (2019) Bounding box regression with uncertainty for accurate object detection. In: IEEE/CVF Conference on Computer Vision and Pattern Recognition (CVPR)
[24] Huang Z, Huang L, Gong Y, Huang C, Wang X (2019) Mask scoring r-cnn. In: IEEE/CVF Conference on Computer Vision and Pattern Recognition (CVPR)
[25] Jiang B, Luo R, Mao J, Xiao T, Jiang Y (2018) Acquisition of localization confidence for accurate object detection. In: The European Conference on Computer Vision (ECCV)
[26] Kahraman F, Oksuz K, Kalkan S, Akbas E (2023) Correlation loss: Enforcing correlation between classification and localization. In: Association for the Advancement of Artificial Intelligence (AAAI)
[27] Kim K, Lee H S (2020) Probabilistic anchor assignment with iou prediction for object detection. In: The European Conference on Computer Vision (ECCV)
[28] Kirillov A, Mintun E, Ravi N, Mao H, Rolland C, Gustafson L, Xiao T, Whitehead S, Berg A C, Lo W Y, Dollár P, Girshick R (2023) Segment anything. arXiv:230402643
[29] Kuleshov V, Fenner N, Ermon S (2018) Accurate uncertainties for deep learning using calibrated regression. In: International Conference on Machine Learning (ICML)
[30] Kumar A, Liang P S, Ma T (2019) Verified uncertainty calibration. In: Advances in Neural Information Processing Systems (NeurIPS), vol 32
[31] Kuppers F, Kronenberger J, Shantia A, Haselhoff A (2020) Multivariate confidence calibration for object detection. In: The IEEE/CVF Conference on Computer Vision and Pattern Recognition (CVPR) Workshops
[32] Kuppers F, Schneider J, Haselhoff A (2022) Parametric and multivariate uncertainty calibration for regression and object detection. In: Safe Artificial Intelligence for Automated Driving Workshop in The European Conference on Computer Vision
[33] Kuznetsova A, Rom H, Alldrin N, Uijlings J R R, Krasin I, Pont-Tuset J, Kamali S, Popov S, Malloci M, Duerig T, Ferrari V (2018) The open images dataset V4: unified image classification, object detection, and visual relationship detection at scale. arXiv 1811.00982
[34] Lakshminarayanan B, Pritzel A, Blundell C (2017) Simple and scalable predictive uncertainty estimation using deep ensembles. In: Guyon I, Luxburg U V, Bengio S, Wallach H, Fergus R, Vishwanathan S, Garnett R (eds) Advances in Neural Information Processing Systems, vol 30
[35] Law H, Deng J (2018) Cornernet: Detecting objects as paired keypoints. In: The European Conference on Computer Vision (ECCV)
[36] Lee H, Eum S, Kwon H (2020) Me r-cnn: Multi-expert r-cnn for object detection. IEEE Transactions on Image Processing 29:1030-1044, DOI 10.1109/TIP.2019.2938879
[37] Li X, Wang W, Hu X, Li J, Tang J, Yang J (2019) Generalized focal loss v2: Learning reliable localization quality estimation for dense object detection. In: IEEE/CVF Conference on Computer Vision and Pattern Recognition (CVPR)
[38] Li X, Wang W, Wu L, Chen S, Hu X, Li J, Tang J, Yang J (2020) Generalized focal loss: Learning qualified and distributed bounding boxes for dense object detection. In: Advances in Neural Information Processing Systems (NeurIPS)
[39] 406 Li Y, Mao H, Girshick R, He K (2022) Exploring plain vision transformer backbones for object detection. In: European Conference on Computer Vision (ECCV)
[40] Li Y, Hou Q, Zheng Z, Cheng M, Yang J, Li X (2023) Large selective kernel network for remote sensing object detection. ArXiv
[41] Lin T, Dollár P, Girshick R B, He K, Hariharan B, Belongie S J (2017) Feature pyramid networks for object detection. In: IEEE/CVF Conference on Computer Vision and Pattern Recognition (CVPR)
[42] Lin T, Goyal P, Girshick R B, He K, Dollár P (2017) Focal loss for dense object detection. In: IEEE/CVF International Conference on Computer Vision (ICCV)
[43] Lin T Y, Maire M, Belongie S, Hays J, Perona P, Ramanan D, Dollar P, Zitnick C L (2014) Microsoft COCO: Common Objects in Context. In: The European Conference on Computer Vision (ECCV)
[44] Lin T Y, Goyal P, Girshick R, He K, Dollár P (2020) Focal loss for dense object detection. IEEE Transactions on Pattern Analysis and Machine Intelligence (TPAMI) 42(2):318-327
[45] Liu Z, Lin Y, Cao Y, Hu H, Wei Y, Zhang Z, Lin S, Guo B (2021) Swin transformer: Hierarchical vision transformer using shifted windows. In: Proceedings of the IEEE/CVF International Conference on Computer Vision (ICCV)
[46] Lyu C, Zhang W, Huang H, Zhou Y, Wang Y, Liu Y, Zhang S, Chen K (2022) Rtmdet: An empirical study of designing real-time object detectors. ArXiv
[47] Mukhoti J, Kulharia V, Sanyal A, Golodetz S, Torr P, Dokania P (2020) Calibrating deep neural networks using focal loss. In: Larochelle H, Ranzato M, Hadsell R, Balcan M, Lin H (eds) Advances in Neural Information Processing Systems, Curran Associates, Inc., vol 33, pp 15288-15299, URL https://proceedings.neurips.cc/paper/2020/file/aeb7b30ef1d024a76f21a1d40e30c302-Paper.pdf
[48] Neumann L, Zisserman A, Vedaldi A (2018) Relaxed softmax: Efficient confidence auto calibration for safe pedestrian detection. In: NIPS MLITS Workshop on Machine Learning for Intelligent Transportation System
[49] Nixon J, Dusenberry M W, Zhang L, Jerfel G, Tran D (2019) Measuring calibration in deep learning. In: IEEE/CVF Conference on Computer Vision and Pattern Recognition (CVPR) Workshops.
[50] Oksuz K, Cam B C, Akbas E, Kalkan S (2018) Localization recall precision (LRP): A new performance metric for object detection. In: The European Conference on Computer Vision (ECCV)
[51] Oksuz K, Cam B C, Akbas E, Kalkan S (2020) A ranking-based, balanced loss function unifying classification and localisation in object detection. In: Advances in Neural Information Processing Systems (NeurIPS)
[52] Oksuz K, Cam B C, Akbas E, Kalkan S (2021) Rank & sort loss for object detection and instance segmentation. In: The International Conference on Computer Vision (ICCV)
[53] Oksuz K, Cam B C, Kalkan S, Akbas E (2021) One metric to measure them all: Localisation recall precision (lrp) for evaluating visual detection tasks. IEEE Transactions on Pattern Analysis and Machine Intelligence pp 1-1
[54] Oksuz K, Joy T, Dokania P (2023) Towards building self-aware object detectors via reliable uncertainty quantification and calibration. In: IEEE/CVF Conference on Computer Vision and Pattern Recognition (CVPR)
[55] Pinto F, Torr P H S, Dokania P K (2022) An impartial take to the cnn vs transformer robustness contest. In: The European Conference on Computer Vision (ECCV).
[56] Ren S, He K, 452 Girshick R, Sun J (2017) Faster R-CNN: Towards real-time object detection with region proposal networks. IEEE Transactions on Pattern Analysis and Machine Intelligence (TPAMI) 39(6):1137-1149
[57] Sun P, Zhang R, Jiang Y, Kong T, Xu C, Zhan W, Tomizuka M, Li L, Yuan Z, Wang C, Luo P (2018) SparseR-CNN: End-to-end object detection with learnable proposals. In: IEEE/CVF Conference on Computer Vision and Pattern Recognition (CVPR)
[58] Sun P, Kretzschmar H, Dotiwalla X, Chouard A, Patnaik V, Tsui P, Guo J, Zhou Y, Chai Y, Caine B, Vasudevan V, Han W, Ngiam J, Zhao H, Timofeev A, Ettinger S, Krivokon M, Gao A, Joshi A, Zhang Y, Shlens J, Chen Z, Anguelov D (2020) Scalability in perception for autonomous driving: Waymo open dataset. In: IEEE/CVF Conference on Computer Vision and Pattern Recognition (CVPR)
[59] Tian Z, Shen C, Chen H, He T (2019) Fcos: Fully convolutional one-stage object detection. In: IEEE/CVF International Conference on Computer Vision (ICCV)
[60] Wang C Y, Bochkovskiy A, Liao H Y M (2022) YOLOv7: Trainable bag-of-freebies sets new state-of-the-art for real-time object detectors. arXiv preprint arXiv:220702696
[61] Wang D B, Feng L, Zhang M L (2021) Rethinking calibration of deep neural networks: Do not be afraid of overconfidence. In: Advances in Neural Information Processing Systems (NeurIPS)
[62] Wang J, Zhang W, Zang Y, Cao Y, Pang J, Gong T, Chen K, Liu Z, Loy C C, Lin D (2020)
Seesaw loss for long-tailed instance segmentation. 2021 IEEE/CVF Conference on Computer Vision and Pattern Recognition (CVPR) pp 9690-9699
[63] Xia G S, Bai X, Ding J, Zhu Z, Belongie S, Luo J, Datcu M, Pelillo M, Zhang L (2018) Dota: A large-scale dataset for object detection in aerial images. In: The IEEE Conference on Computer Vision and Pattern Recognition (CVPR)
[64] Xie S, Girshick R B, Dollar P, Tu Z, He K (2016) Aggregated residual transformations for deep neural networks. arXiv 1611.05431
[65] Yan K, Wang X, Lu L, Summers RM (2018) “deeplesion: Automated mining of large-scale lesion annotations and universal lesion detection with deep learning”. Journal of Medical Imaging 5(3)
[66] Zadrozny B, Elkan C (2002) Transforming classifier scores into accurate multiclass probability estimates. In: Proceedings of the eighth ACM SIGKDD international conference on Knowledge discovery and data mining, pp 694-699
[67] Zhang H, Chang H, Ma B, Wang N, Chen X (2020) Dynamic r-cnn: Towards high quality object detection via dynamic training. In: The European Conference on Computer Vision (ECCV)
[68] Zhang H, Wang Y, Dayoub F, Sünderhauf N (2021) Varifocalnet: An iou-aware dense object detector. In: IEEE/CVF Conference on Computer Vision and Pattern Recognition (CVPR)
[69] Zhang S, Chi C, Yao Y, Lei Z, Li S Z (2020) Bridging the gap between anchor-based and anchor-free detection via adaptive training sample selection. In: IEEE/CVF Conference on Computer Vision and Pattern Recognition (CVPR)
[70] Zhao S, Zhang Z, Schulter S, Zhao L, Vijay Kumar B, Stathopoulos A, Chandraker M, Metaxas D N (2022) Exploiting unlabeled data with vision and language models for object detection. In: European Conference on Computer Vision (ECCV)
[71] Zhu X, Su W, Lu L, Li B, Wang X, Dai J (2021) Deformable {detr}: Deformable transformers for end-to-end object detection. In: International Conference on Learning Representations (ICLR)
[72] Zoph B, Cubuk E D, Ghiasi G, Lin T Y, Shlens J, Le Q V (2020) Learning data augmentation strategies for object detection. In: European Conference on Computer Vision (ECCV)
[73] Zoph B, Ghiasi G, Lin T Y, Cui Y, Liu H, Cubuk E D, Le Q (2020) Rethinking pretraining and self-training. In: Larochelle H, Ranzato M, Hadsell R, Balcan M, Lin H (eds) Advances in Neural Information Processing Systems, Curran Associates, Inc., vol 33, pp 3833-3845

1. A computer-implemented method of calibrating an object detector, the method comprising:
for each scene of an annotated sensor data set:
applying the object detector to the scene, resulting in one or more predicted object regions and an uncalibrated confidence score associated with each predicted object region,
calculating a corresponding target confidence score for each predicted object region as an intersection over union (IoU) between the predicted object region and a corresponding ground truth (annotated) object region associated with the annotated scene, thereby obtaining a set of observations, each observation comprising an uncalibrated confidence score and a corresponding target confidence score; and
fitting a score calibration function to the set of observations, thereby enabling the score calibration function to predict a calibrated confidence score for a given uncalibrated confidence score.

2. The method of claim 1, wherein applying the object detector to the scene may additionally result in a predicted class for each predicted object region.

3. The method of claim 1, wherein the observations are input-output pairs, where the uncalibrated confidence score is an input and the corresponding target confidence score for calibration is an output.

4. A computer-implemented method of detecting one or more objects in a scene using multiple calibrated object detectors, the method comprising:
applying each calibrated object detector to the scene, resulting in one or more predicted object regions for each calibrated object detector and an uncalibrated confidence score for each predicted object region;
for each calibrated detector, using its score calibration function to determine a calibrated confidence score for each predicted object region; and
applying a reduction algorithm to a combined prediction set comprising the one or more predicted object regions for each object detector and their calibrated confidence scores, resulting in a reduced prediction set.

5. The method of claim 4, wherein applying each calibrated object detector may result in a predicted class for each predicted object region.

6. The method of claim 4, wherein the reduction algorithm is applied for each predicted class independently.

7. The method of claim 6, wherein the object detectors do not operate on identical sets of classes, and the predicted classes is transformed as needed to a common set of classes before applying the reduction algorithm.

8. The method of claim 6, wherein the reduction algorithm is used to account for duplicate object detection(s) in the combined prediction set, in a way that respects their calibrated confidence scores.

9. The method of claim 8, wherein identification of duplicate detections considers an extent of overlap between predicted object regions as well as their calibrated scores.

10. The method of claim 9, wherein, the reduction algorithm involves selectively re-scoring the predicted object regions, such that the calibrated confidence scores are reduced for certain object region(s), taking into account how likely they are to be duplicates.

11. The method of claim 9, wherein the reduction algorithm refines the object regions by determining a weighted average of the predicted object regions (e.g. within a given predicted class) based on re-calibrated scores.

12. The method of claim 10, wherein one or more scores for one or more overlapping regions are reduced via soft non-maximal suppression (NMS), and
wherein the reduction algorithm optionally combines NMS with a process of refining remaining predicted object regions from the combined prediction set based on the calibrated confidence score and the overlap of each remaining predicted object region with other predicted object regions.

13. (canceled)

14. The method of claim 10, wherein the score calibration function is a parameterized function, where fitting involves fitting one or more parameters of the score calibration function to one or more observations.

15. The method of claim 10, wherein the score calibration function is a trainable machine learning (ML) model.

16. The method of claim 1, wherein the predicted object region is a bounding box, rotated bounding box, or a segmentation regions etc.

17. The method of claim 1, wherein the object detector is a form of object localization, bounding box detection, bounding box rotation or scene segmentation.

18. The method of claim 1, wherein a scene is 2D or 3D, and is formatted as an image, point cloud, surface mesh representation or voxel representation.

19. (canceled)

20. The method of claim 1, wherein the object detectors are a machine learning (ML) models with different architectures, in a mixture of experts (MoE) approach.

21. The method of claim 4, wherein the object detectors are calibrated using a method comprising:
for each scene of an annotated sensor data set:
applying the object detector to the scene, resulting in one or more predicted object regions and an uncalibrated confidence score associated with each predicted object region,
calculating a corresponding target confidence score for each predicted object region as an intersection over union (IoU) between the predicted object region and a corresponding around truth (annotated) object region associated with the annotated scene, thereby obtaining a set of observations, each observation comprising an uncalibrated confidence score and a corresponding target confidence score; and
fitting a score calibration function to the set of observations, thereby enabling the score calibration function to predict a calibrated confidence score for a given uncalibrated confidence score.

22. A computer system for calibrating an object detector, the computer system comprising:
at least one memory storing computer-readable instructions; and
at least one processor coupled to the at least one memory configured to execute the computer-readable instructions, which upon execution cause the at least one processor to perform operations including:
for each scene of an annotated sensor data set:
apply the object detector to the scene, resulting in one or more predicted object regions and an uncalibrated confidence score associated with each predicted object region,
calculate a corresponding target confidence score for each predicted object region as an intersection over union (IoU) between the predicted object region and a corresponding around truth (annotated) object region associated with the annotated scene, thereby obtaining a set of observations, each observation comprising an uncalibrated confidence score and a corresponding target confidence score; and
fit a score calibration function to the set of observations, thereby enabling the score calibration function to predict a calibrated confidence score for a given uncalibrated confidence score.

23. (canceled)
